(19) United States
(12) Patent Application Publication
(10) Pub. No.: US 2024/0121693 A1
(43) Pub. Date: Apr. 11, 2024

(54) REDUCED FLIGHT PATH REPORTING OVERHEAD

(71) Applicant: QUALCOMM Incorporated, San Diego, CA (US)

(72) Inventors: Chiranjib SAHA, San Diego, CA (US); Umesh PHUYAL, San Diego, CA (US); Le LIU, San Jose, CA (US); Sunghoon KIM, San Diego, CA (US); Stefano FACCIN, San Ysidro, CA (US)

(21) Appl. No.: 18/473,710

(22) Filed: Sep. 25, 2023

Related U.S. Application Data
(60) Provisional application No. 63/378,835, filed on Oct. 7, 2022.

(51) Int. Cl. H04W 36/32; G08G 5/00

(52) U.S. Cl. CPC H04W 36/322; G08G 5/0008; G08G 5/0039

(57) ABSTRACT

Various aspects of the present disclosure generally relate to wireless communication. In some aspects, a network node may transmit a flight path information request that indicates a differential flight path reporting configuration that is associated with user equipment (UE) flight path information associated with a UE. The network node may receive the UE flight path information, the UE flight path information being based at least in part on the differential flight path reporting configuration. Numerous other aspects are described.

### CROSS-REFERENCE TO RELATED APPLICATION

This patent application claims priority U.S. Patent Application No. 63/378,835, filed on Oct. 7, 2022, entitled “REDUCED FLIGHT PATH REPORTING OVERHEAD,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for reduced flight path reporting overhead.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

An unmanned aerial vehicle (UAV) user equipment (UE) changing locations may experience radio link failures multiple times and/or transition into an idle mode multiple times while airborne and/or flying. A network node communicating with the UAV UE may lose flight path information associated with the UAV based at least in part on the UAV transitioning to the idle mode. Accordingly, the network node 110 may transmit a request for flight path information from the UAV based at least in part on the UAV reconnecting to the network node and/or the UAV transitioning to a connected state. Alternatively or additionally, the UAV UE may transmit a reply that includes the flight path information. The multiple requests for flight path information and the multiple flight path information replies may increase an overhead associated with the UAV and the network node maintaining a wireless link and/or consume an amount of air interface resources that result in increased data transfer latencies within a wireless network, reduced capacity by the wireless network (e.g., the wireless network may service fewer devices), and/or decreased data throughput.

Some aspects described herein relate to a method of wireless communication performed by an apparatus of a network node. The method may include transmitting a flight path information request that indicates a differential flight path reporting configuration that is associated with UE flight path information associated with a UE. The method may include receiving the UE flight path information, the UE flight path information being based at least in part on the differential flight path reporting configuration.

Some aspects described herein relate to a method of wireless communication performed by an apparatus of a UE. The method may include receiving an indication that indicates that a network node supports differential flight path information. The method may include receiving a flight path information request from the network node. The method may include transmitting a response to the flight path information request that is based at least in part on the network node supporting the differential flight path information.

Some aspects described herein relate to a method of wireless communication performed by an apparatus of a UE. The method may include detecting a UE flight path change that satisfies a threshold. The method may include transmitting a flight path change indication to a network node.

Some aspects described herein relate to a method of wireless communication performed by an apparatus of network node. The method may include receiving, from a UE, last reported UE flight path information. The method may include receiving, without transmitting a flight path information request and from the UE, a flight path change indication that is associated with a UE flight path change.

Some aspects described herein relate to an apparatus for wireless communication at an network node. The apparatus may include one or more memories and one or more processors coupled to the one or more memories. The one or more processors may be configured, individually or collectively, to transmit a flight path information request that indicates a differential flight path reporting configuration that is associated with UE flight path information associated with a UE. The one or more processors may be configured, individually or collectively, to receive the UE flight path information, the UE flight path information being based at least in part on the differential flight path reporting configuration.

Some aspects described herein relate to an apparatus for wireless communication at a UE. The apparatus may include one or more memories and one or more processors coupled to the one or more memories. The one or more processors may be configured, individually or collectively, to receive an indication that indicates that a network node supports differential flight path information. The one or more processors may be configured to receive a flight path information request from the network node. The one or more processors may be configured to transmit a response to the flight path information request that is based at least in part on the network node supporting the differential flight path information.

Some aspects described herein relate to an apparatus for wireless communication at a UE. The apparatus may include one or more memories and one or more processors coupled to the one or more memories. The one or more processors may be configured, individually or collectively, to detect a UE flight path change that satisfies a threshold. The one or more processors may be configured, individually or collectively, to transmit a flight path change indication to a network node.

Some aspects described herein relate to an apparatus for wireless communication at a network node. The apparatus may include one or more memories and one or more processors coupled to the one or more memories. The one or more processors may be configured, individually or collectively, to receive, from a UE, last reported UE flight path information. The one or more processors may be configured, individually or collectively, to receive, without transmitting a flight path information request and from the UE, a flight path change indication that is associated with a UE flight path change.

Some aspects described herein relate to a non-transitory computer-readable medium that stores a set of instructions for wireless communication by an apparatus. The set of instructions, when executed by one or more processors of the apparatus, may cause the apparatus to transmit a flight path information request that indicates a differential flight path reporting configuration that is associated with UE flight path information associated with a UE. The set of instructions, when executed by one or more processors of the apparatus, may cause the apparatus to receive the UE flight path information, the UE flight path information being based at least in part on the differential flight path reporting configuration.

Some aspects described herein relate to a non-transitory computer-readable medium that stores a set of instructions for wireless communication by an apparatus. The set of instructions, when executed by one or more processors of the apparatus, may cause the apparatus to receive an indication that indicates that a network node supports differential flight path information. The set of instructions, when executed by one or more processors of the apparatus, may cause the apparatus to receive a flight path information request from the network node. The set of instructions, when executed by one or more processors of the apparatus, may cause the apparatus to transmit a response to the flight path information request that is based at least in part on the network node supporting the differential flight path information.

Some aspects described herein relate to a non-transitory computer-readable medium that stores a set of instructions for wireless communication by an apparatus. The set of instructions, when executed by one or more processors of the apparatus, may cause the apparatus to detect a UE flight path change that satisfies a threshold. The set of instructions, when executed by one or more processors of the apparatus, may cause the apparatus to transmit a flight path change indication to a network node.

Some aspects described herein relate to a non-transitory computer-readable medium that stores a set of instructions for wireless communication by an apparatus. The set of instructions, when executed by one or more processors of the apparatus, may cause the apparatus to receive, from a UE, last reported UE flight path information. The set of instructions, when executed by one or more processors of the apparatus, may cause the apparatus to receive, without transmitting a flight path information request and from the UE, a flight path change indication that is associated with a UE flight path change.

Some aspects described herein relate to an apparatus for wireless communication. The apparatus may include means for transmitting a flight path information request that indicates a differential flight path reporting configuration that is associated with UE flight path information associated with a UE. The apparatus may include means for receiving the UE flight path information, the UE flight path information being based at least in part on the differential flight path reporting configuration.

Some aspects described herein relate to an apparatus for wireless communication. The apparatus may include means for receiving an indication that indicates that a network node supports differential flight path information. The apparatus may include means for receiving a flight path information request from the network node. The apparatus may include means for transmitting a response to the flight path information request that is based at least in part on the network node supporting the differential flight path information.

Some aspects described herein relate to an apparatus for wireless communication. The apparatus may include means for detecting a UE flight path change that satisfies a threshold. The apparatus may include means for transmitting a flight path change indication to a network node.

Some aspects described herein relate to an apparatus for wireless communication. The apparatus may include means for receiving, from a UE, last reported UE flight path information. The apparatus may include means for receiving, without transmitting a flight path information request and from the UE, a flight path change indication that is associated with a UE flight path change.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of an unmanned arial vehicle UE in a wireless communication network environment, in accordance with the present disclosure.

FIG. 5 is a diagram illustrating an example of a wireless communication process between a UE, a first network node, and a second network node, in accordance with the present disclosure.

FIG. 6 is a diagram illustrating an example of a wireless communication process between a UE and a network node, in accordance with the present disclosure.

FIG. 7 is a diagram illustrating an example process performed, for example, at a network node or an apparatus of a network node, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

An unmanned aerial vehicle (UAV) user equipment (UE) changing locations may experience radio link failures multiple times and/or transition into the idle mode multiple times while airborne and/or flying. A network node communicating with the UAV UE may lose flight path information associated with the UAV based at least in part on the UAV transitioning to the idle mode. Accordingly, the network node 110 may transmit a request for flight path information from the UAV based at least in part on the UAV reconnecting to the network node and/or the UAV transitioning to a connected state. Alternatively or additionally, the UAV UE may transmit a reply that includes the flight path information. The multiple requests for flight path information and the multiple flight path information replies may increase an overhead associated with the UAV and the network node maintaining a wireless link and/or consume an amount of air interface resources that result in increased data transfer latencies within a wireless network, reduced capacity by the wireless network (e.g., the wireless network may service fewer devices), and/or decreased data throughput.

Various aspects described herein generally relate to reduced flight path reporting overhead. Some aspects relate more specifically to a network node instructing a UE to transmit differential flight path information. In some aspects, a network node may transmit a flight path information request that indicates a differential flight path reporting configuration that is associated with UE flight path information. For example, the network node may transmit the flight path information to a UE, and the flight path information request may indicate to return differential flight path information. In some aspects, the network node may receive the UE flight path information, and the UE flight path information may be based at least in part on the differential flight path reporting configuration. For example, the UE flight path information may indicate differential flight path information.

Differential flight path information may reduce overhead signaling that is associated with maintaining a wireless link between a network node and a UAV UE. The reduced overhead signaling may reduce an amount of air interface resources used by the overhead signaling and, subsequently, may result in reduced data transfer latencies within a wireless network, increased capacity by the wireless network (e.g., the wireless network may service more devices), and/or increase data throughput.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

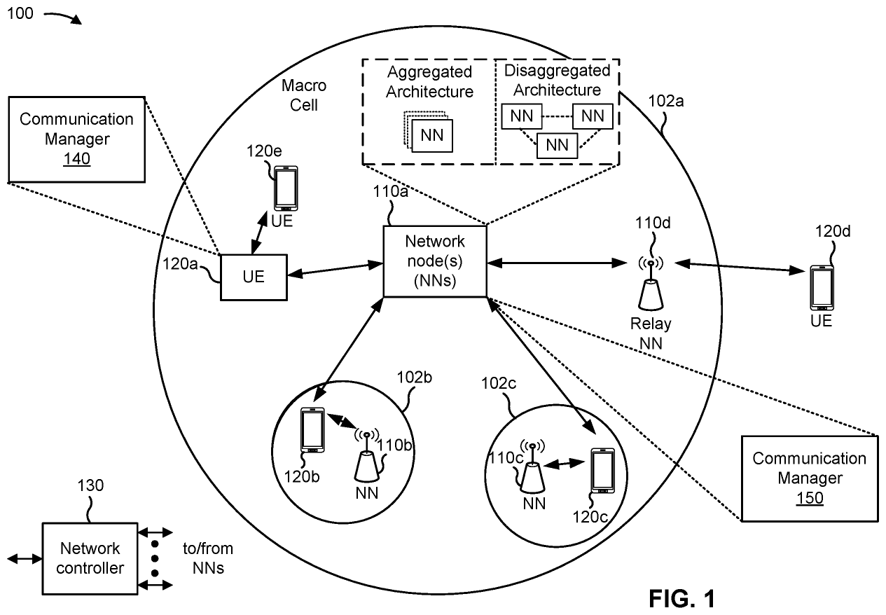

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node (e.g., a network node 110) may include a communication manager 150. As described in more detail elsewhere herein, the communication manager 150 may transmit a flight path information request that indicates a differential flight path reporting configuration that is associated with UE flight path information associated with a UE; and receive the UE flight path information, the UE flight path information being based at least in part on the differential flight path reporting configuration.

In some aspects, and as described in more detail elsewhere herein, the communication manager 150 may receive, from a UE, last reported UE flight path information; and receive, without transmitting a flight path information request and from the UE, a flight path change indication that is associated with a UE flight path change. Additionally, or alternatively, the communication manager 150 may perform one or more other operations described herein.

In some aspects, a UE (e.g., a UE 120) may include a communication manager 140. As described in more detail elsewhere herein, the communication manager 140 may receive an indication that indicates that a network node supports differential flight path information; receive a flight path information request from the network node; and transmit a response to the flight path information request that is based at least in part on the network node supporting the differential flight path information.

In some aspects, and as described in more detail elsewhere herein, the communication manager 140 may detect a UE flight path change that satisfies a threshold; and transmit a flight path change indication to a network node. Additionally, or alternatively, the communication manager 140 may perform one or more other operations described herein.

As indicated above, FIG. 1 is provided as an example. Other examples may differ from what is described with regard to FIG. 1.

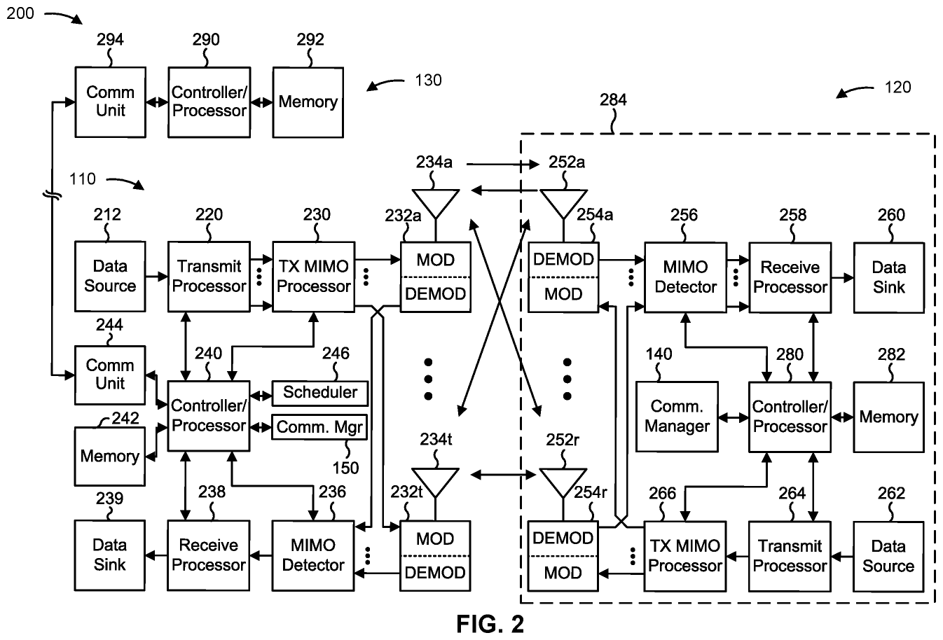

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294. One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

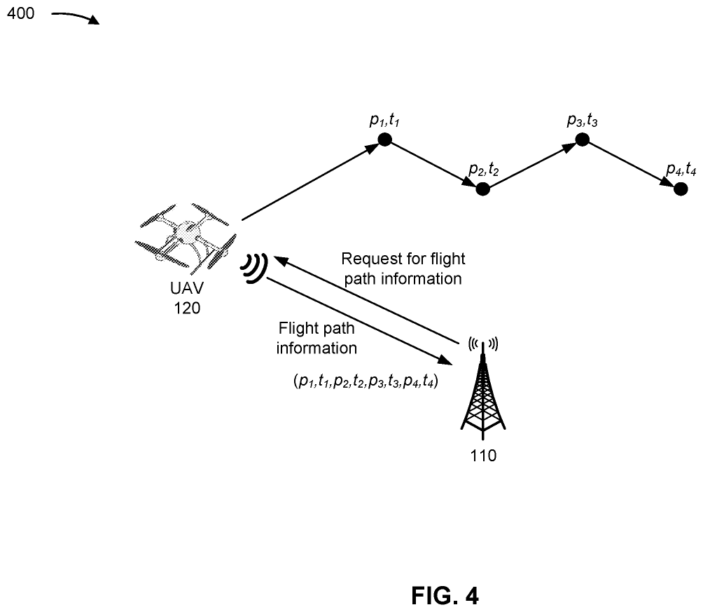

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

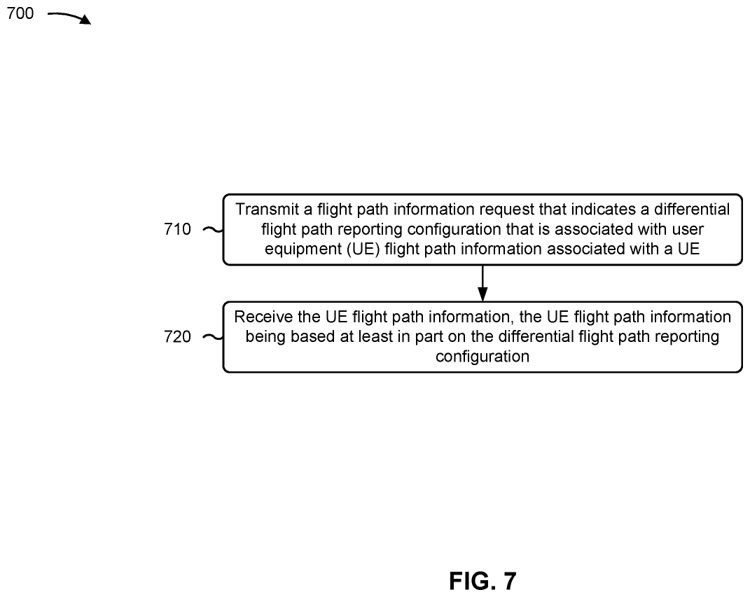

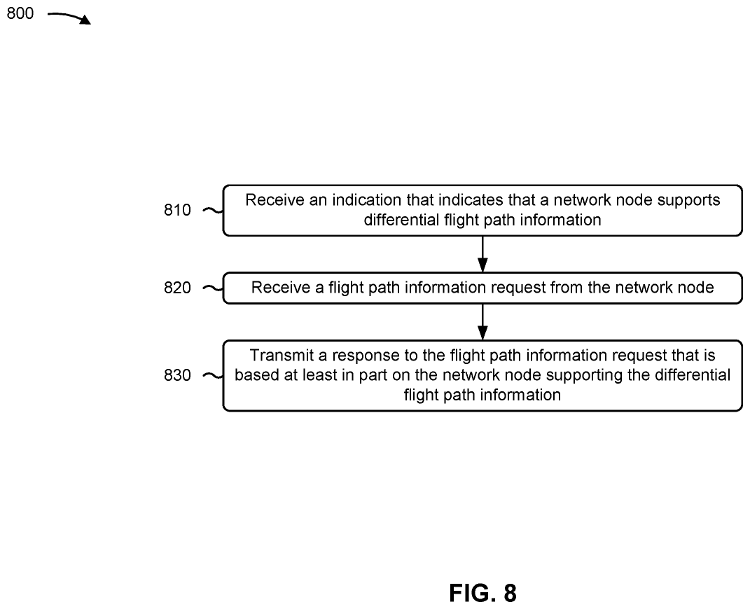

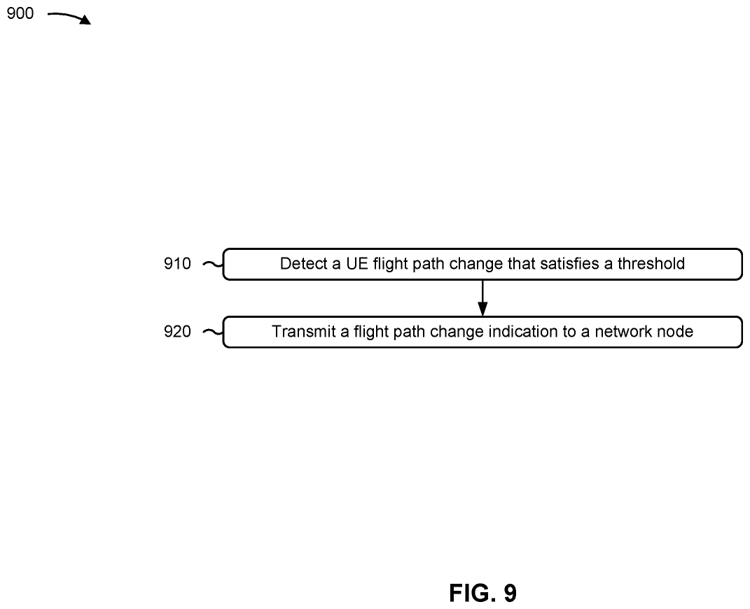

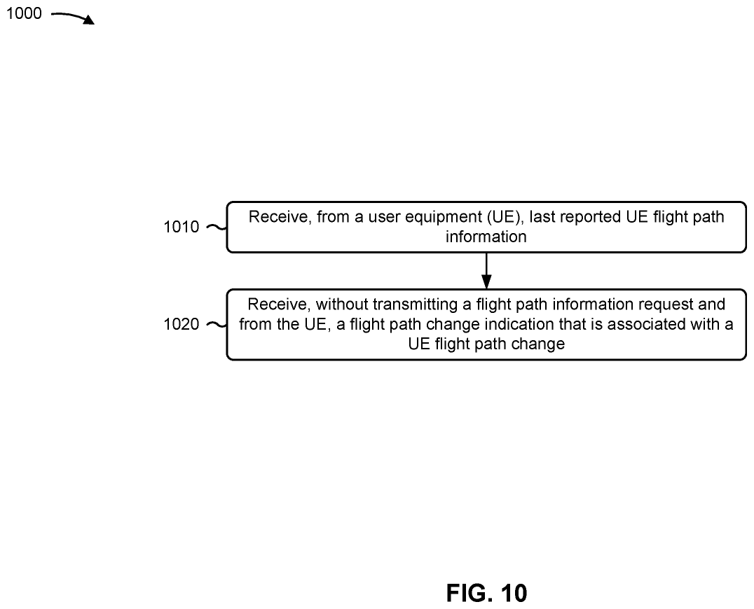

The controller/processor 240 of the network node 110, the controller/processor 280 of the UE 120, and/or any other component(s) of FIG. 2 may perform one or more techniques associated with for reduced flight path reporting overhead, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a network node (e.g., a network node 110) includes means for transmitting a flight path information request that indicates a differential flight path reporting configuration that is associated with UE flight path information associated with a UE; and/or means for receiving the UE flight path information, the UE flight path information being based at least in part on the differential flight path reporting configuration.

Alternatively, or additionally, the network node includes means for receiving, from a UE, last reported UE flight path information; and/or means for receiving, without transmitting a flight path information request and from the UE, a flight path change indication that is associated with a UE flight path change. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., a UE 120) includes means for receiving an indication that indicates that a network node supports differential flight path information; means for receiving a flight path information request from the network node; and/or means for transmitting a response to the flight path information request that is based at least in part on the network node supporting the differential flight path information.

Alternatively, or additionally, the UE includes means for detecting a UE flight path change that satisfies a threshold; and/or means for transmitting a flight path change indication to a network node. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station (BS), a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

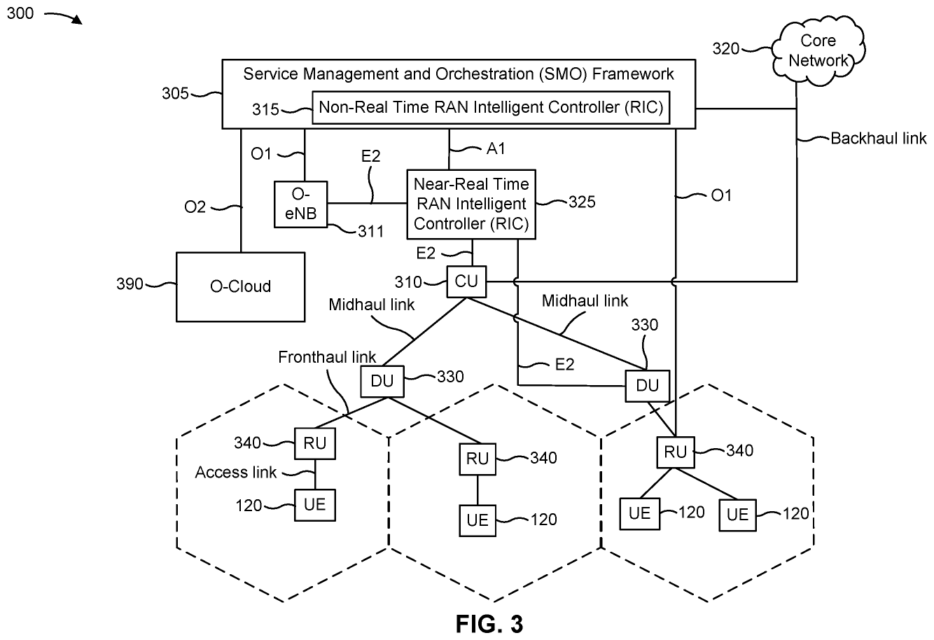

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of an unmanned aerial vehicle (UAV) UE in a wireless communication network environment, in accordance with the present disclosure. As shown in FIG. 4, example 400 includes a network node 110 and a UAV UE 120 (also referred to herein as the UAV 120).

The UAV 120 includes an aircraft without a human pilot aboard and can also be referred to as an unmanned aircraft (UA), a drone, a remotely piloted vehicle (RPV), a remotely piloted aircraft (RPA), a remotely operated aircraft (ROA), or an uncrewed aerial vehicle. The UAV 120 may have a variety of shapes, sizes, configurations, characteristics, or the like for a variety of purposes and applications. In some implementations, the UAV 120 may include one or more sensors, such as an electromagnetic spectrum sensor (e.g., a visual spectrum, infrared, or near infrared camera, a radar system, or the like), a biological sensor, a temperature sensor, and/or a chemical sensor, among other examples. The UAV 120 may include one or more components for communicating with one or more network nodes 110.

The UAV 120 may communicate with the network node 110 via a Uu interface. For example, the UAV 120 may transmit uplink communications to the network node 110 and/or receive downlink communications from the network node 110 via the Uu interface. Such Uu connectivity may be used to support different applications for the UAV 120, such as video transmission from the UAV 120 or C2 communications for remote command and control of the UAV 120, among other examples.

As shown in FIG. 4, in some examples, the network node 110 may transmit, to the UAV 120, a request for flight path information. The UAV 120 may receive the request for the flight path information, and the UAV 120 may transmit the flight path information to the network node 110 if the flight path information is available at the UAV 120. In some examples, the UAV 120 may indicate, to the network node 110, whether the UAV 120 has flight path information available (e.g., when an RRC connection between the UAV 120 and the network node 110 is initiated). The flight path information may indicate a planned or projected flight path of the UAV 120. In some examples, the flight path information may include a set of waypoints (p₁, p₂, . . . , pₙ) and corresponding time-stamps (t₁, t₂, . . . , tₙ). The waypoints (p₁, p₂, . . . , pₙ) indicate planned or projected positions of the UAV 120, and the time-stamps (t₁, t₂, . . . , tₙ) indicate expected arrival times of the UAV 120 at the corresponding waypoints (p₁, p₂, . . . , pₙ) For example, as shown in FIG. 4, p₁, t₁ indicates a position and an expected arrival time for a first waypoint (Waypoint 1), p₂, t₂ indicates a position and an expected arrival time for a second waypoint (Waypoint 2), p₃, t₃ indicates a position and an expected arrival time for a third waypoint (Waypoint 3), and p₄, t₄ indicates a position and an expected arrival time for a fourth waypoint (Waypoint 4). In some examples, the flight path information may be used by the network to track how many UAVs are to be served in an area at a given time.

A UAV may go into an idle state (e.g., an RRC_IDLE state) while airborne and/or flying. To illustrate, the UAV may experience radio link failure (RLF) based at least in part on moving from a first location with strong coverage from a network node to a second location with weaker coverage from the network node relative to the first location. For example, a radiation pattern of the network node may direct main lobes of the radiation towards terrestrial coverage (e.g., non-aerial UEs) and sidelobes of the radiation pattern towards aerial coverage. Thus, a UAV moving locations may experience RLF multiple times and/or transition into the idle mode multiple times while airborne and/or flying.

A network node may lose flight path information associated with the UAV based at least in part on the UAV transitioning to the idle mode. Accordingly, the network node 110 may transmit a request for flight path information from the UAV based at least in part on the UAV reconnecting to the network node and/or the UAV transitioning to a connected state (e.g., an RRC_CONNECTED state), and the UAV may transmit a reply that includes the flight path information as described above. In some aspects, the flight path information returned by the UAV after transitioning back to the connected state may include minimal changes relative to prior flight information at an earlier time. That is, the flight path information may include commensurate information (e.g., information that is within a range of values and/or within a threshold value) to the prior flight path information. Thus, the multiple requests for flight path information and the multiple flight path information replies (e.g., associated with the UAV transitioning between the idle state and the connected state multiple times) may increase an overhead associated with the UAV and the network node maintaining a wireless link and/or consume an amount of air interface resources that result in increased data transfer latencies within a wireless network, reduced capacity by the wireless network (e.g., the wireless network may service fewer devices), and/or decreased data throughput.

Some techniques and apparatuses described herein provide reduced flight path reporting overhead. In some aspects, a network node may communicate a flight path information request to a core network, and the flight path information request may be associated with a UE (e.g., a particular UE 120 and/or a particular UAV 120). The network node may receive from the core network, a response to the flight path information request. As one example, the core network may include, in the response, prior flight path information associated with the UE and/or a flight path identifier (ID). As another example, the core network may include, in the response, an indication that the core network lacks flight path information associated with the UE. Based at least in part on the response from the core network, the network node may transmit a flight path query to the UE. Alternatively, or additionally, the network node may transmit an indication that indicates the network node supports differential flight path information. In some aspects, the flight path query may indicate the flight path ID and/or a timestamp that enables the UE to transmit less flight path information to the network node, such as differential flight path information and/or an indication of no flight path information, and reduce an overhead associated with maintaining a wireless link between the network node and the UAV by using less air interface resources relative to transmitting full flight path information.

In some aspects, a UE (e.g., the UE 120 and/or the UAV 120) may receive an indication that indicates that a network node supports differential flight path information. Alternatively, or additionally, the UE may receive a flight path query from the network node, and the UE may transmit a response to the flight path query that is based at least in part on the network node supporting the differential flight path information. For example, the UE may transmit differential flight path information and/or an indication of no flight path information using less air interface resources relative to transmitting full flight path information and/or reduce an overhead associated with maintaining a wireless link between the network node and the UAV.

In some aspects, a UE (e.g., the UE 120 and/or the UAV 120) may detect a UE flight path change (e.g., a flight path change to flight path information associated with the UE) that satisfies a threshold. Based at least in part on detecting the UE flight path change, the UE may transmit a flight path change indication to a network node. In some aspects, the UE may transmit the flight path change indication to the network node without receiving a flight path query from the network node. Transmitting the flight path change indication (e.g., without receiving a flight path query) may reduce an overhead associated with maintaining a wireless link between the network node and the UAV.

In some aspects, a network node (e.g., the network node 110) may receive last reported UE flight path information that is associated with a UE (e.g., the UE 120 and/or the UAV 120). In some aspects, the network node may receive the last reported UE flight path information from the UE, for example, based at least in part on transmitting a request and/or query for UE flight path information to the UE. The network node may identify the UE flight path information as the last reported UE flight path information based at least in part on a timestamp. Alternatively, or additionally, the network node may receive the last reported UE flight path information from a core network. In some aspects, and after the network node receives the last reported UE flight path information, the network node may receive, without transmitting a flight path query and from the UE, a flight path change indication that is associated with a UE flight path change. Receiving the flight path change indication without transmitting a flight path query may reduce an overhead associated with maintaining a wireless link between the network node and the UAV.

Differential flight path information may reduce overhead signaling that is associated with maintaining a wireless link between the network node and the UAV and, subsequently, may reduce an amount of air interface resources used by the overhead signaling. Reducing air interface resource consumption may result in reduced data transfer latencies within a wireless network, increased capacity by the wireless network (e.g., the wireless network may service more devices), and/or increase data throughput.

As indicated above, FIG. 4 is provided as an example 400 of a UAV. Other examples may differ from what is described with respect to FIG. 4.

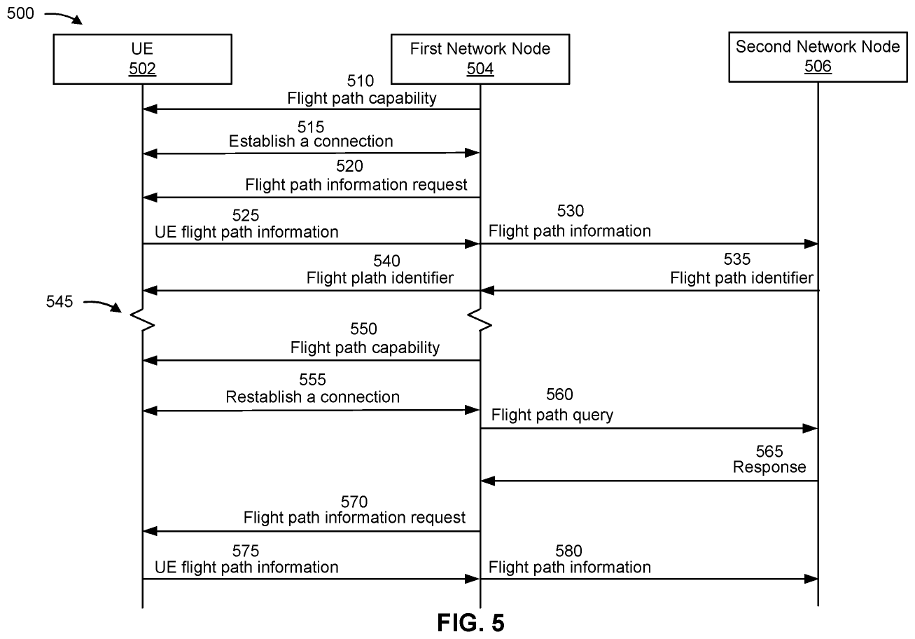

FIG. 5 is a diagram illustrating an example 500 of a wireless communication process between a UE 502 (e.g., a UE 120 and/or UAV 120), a first network node 504 (e.g., a network node 110), and a second network node 506 (e.g., another network node 110 and/or a core network node), in accordance with the present disclosure.

As shown by reference number 510, a first network node 504 may transmit, and a UE 502 may receive, an indication of a flight path capability supported by the first network node 504. To illustrate, the first network node 504 may broadcast the indication of the flight path capability in system information (SI), and the UE 502 may receive the flight path capability by recovering the SI. In other examples, the first network node 504 may indicate the flight path capability in a unicast message and based at least in part on establishing a connection with the UE 502.

As one example of a flight path capability, the first network node 504 may transmit an indication for support of differential flight path information. Alternatively, or additionally, the first network node 504 may transmit a flight path capability configuration. To illustrate, the first network node 504 may indicate a current state of the flight path capability, such as by indicating that differential flight path support (e.g., by the first network node 504) is enabled and/or disabled. For instance, the SI may optionally include and/or exclude a binary flag (e.g., an optional differentialFlightPathReporting flag). A lack of presence of the binary flag may indicate that the first network node 504 does not include support for differential flight path information reporting and/or that differential flight path information reporting is disabled. A presence of the (optional) binary flag may indicate that the first network node 504 supports differential flight path information reporting. A first value for the flag (e.g., “0”) may indicate a disabled state of differential flight path information reporting at the first network node 504, and a second value for the flag (e.g., “1”) may indicate an enabled state of differential flight path information reporting at the first network node 504.

As another example of a flight path capability configuration, the first network node 504 may indicate a time span that is associated with validating differential flight path information (e.g., a validity duration) as described below. The first network node 504 may broadcast the flight path capability configuration information in SI and/or may transmit the flight path capability configuration information in a groupcast and/or unicast message based at least in part on establishing a connection with the UE 502 as described with regard to reference number 515.

In some aspects, the first network node 504 may indicate, as at least part of the flight path capability configuration and/or differential flight path configuration information included in the flight path configuration information, a trigger event that is associated with autonomous and/or asynchronous reporting of differential flight path information. For instance, differential flight path configuration information may indicate any combination of a location change threshold, a time change threshold, a lateral position change threshold, a longitudinal position change threshold, and/or an altitude change threshold, and a UE (e.g., the UE 502) that detects that a threshold has been satisfied (or vice versa) may determine to autonomously transmit differential flight path information as described below. The first network node 504 may broadcast the different differential flight path configuration information in SI or transmit the differential flight path configuration information in a unicast message based at least in part on establishing a connection with the UE 502 as described with regard to reference number 515.

As shown by reference number 515, the UE 502 and the first network node 504 may establish a connection, such as a communication link (e.g., a wireless link). Alternatively, or additionally, the network node 110 and the UE 120 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the communication link, the network node 110 may transmit configuration information via Layer 3 signaling (e.g., RRC signaling), and activate and/or deactivate a particular configuration indicated in the configuration information via Layer 2 signaling (e.g., a MAC CE) and/or Layer 1 signaling (e.g., DCI). To illustrate, the network node 110 may transmit the configuration information via Layer 3 signaling at a first point in time associated with the UE being tolerant of communication delays, and the network node 110 may transmit an activation of the configuration via Layer 2 signaling and/or Layer 1 signaling at a second point in time associated with the UE being intolerant to communication delays.

The ordering of the first network node 504 transmitting a flight path capability and the first network node 504 and the UE 502 establishing a connection may differ from the order included in the example 500. To illustrate, the first network node 504 and the UE 502 may first establish a connection, and the first network node 504 may transmit the flight path capability (e.g., to the UE 502) after establishing the connection, such as by transmitting and/or indicating the flight path capability in a unicast message to the UE 502.

As shown by reference number 520, the first network node 504 may transmit, and the UE 502 may receive, a flight path information request, such as by transmitting the flight path information request in a unicast message (e.g., RRC signaling). In some aspects, the first network node 504 may determine that the connection with the UE 502 is an initial connection and/or a first connection with the UE 502. Based at least in part on determining that the connection is an initial connection and/or a first connection, the first network node 504 may transmit the flight path information request. Alternatively, or additionally, the first network node 504 may transmit the flight path information request independently of the connection being a first connection or a subsequent connection. That is, the first network node 504 may transmit the flight path information request based at least in part on establishing and/or reestablishing a connection with the UE 502. In some aspects, the first network node 504 may indicate a timestamp in the flight path information request, such as a timestamp that is associated with last reported flight path information (e.g., if applicable to the UE 502).

As one example, the first network node 504 may transmit an information element (IE) that indicates a configuration for returning flight path information. For instance, the first network node 504 may transmit a UE information request IE that is configured as follows:

```
UEInformationRequest ::= SEQUENCE {
  IdleModeMeasurementReq-r15 ENUMERATED {true} OPTIONAL, -- Need
  ON
  flightPathInfoReq FlightPathInfoReportConfig OPTIONAL, -- Need ON
  nonCriticalExtension UEInformationRequest-v1710-IEs OPTIONAL
  }
```

and the first network node 504 may include the optional IE flightpathInfoReq (e.g., an instance of a FlightPathInfoReportConfig IE) to indicate a request for flight path information. A FlightPathInfoReportConfig IE may be configured as follows:

```
FlightPathInfoReportConfig ::= SEQUENCE {
  maxWayPointNumber INTEGER (1..maxWayPoint-r15),
  includeTimeStamp ENUMERATED {true} OPTIONAL,
  timeStampofLastReportedFlightPath <<timestamp>> OPTIONAL
  }
```

where maxWayPointNumber indicates a maximum number of waypoints to include in the flight path information, optional field includeTimeStamp indicates whether or not to return a timestamp associated with the flight path information, and optional field timeStampofLastReportedFlightPath indicates a timestamp that is associated with prior flightpath information. In some aspects, the first network node 504 may omit the optional field timeStampofLastReportedFlightPath based at least in part on not having prior flight path information that is associated with the UE 502.

Alternatively, or additionally, the FlightPathInfoReportConfig IE may be configured as follows:

```
FlightPathInfoReportConfig ::= SEQUENCE {
  maxWayPointNumber INTEGER (1..maxWayPoint-r15),
  includeTimeStamp ENUMERATED {true} OPTIONAL,
  differentialReporting ENUMERATED {true} OPTIONAL
  }
```

where maxWayPointNumber indicates a maximum number of waypoints to include in the flight path information, optional field includeTimeStamp indicates whether or not to return a timestamp associated with the flight path information, and optional field differentialReporting may indicate to enable (e.g., via a value of true) or disable (e.g., via a value of false) differential flight path reporting at the UE 502. For example, differential flight path reporting being enabled may instruct the UE 502 to maintain reported flight path information, such as in a last reported flight path buffer that is local to the UE 502 and enables the UE 502 to store reported flight path information (e.g., full flight path information and/or differential flight path information). Alternatively, or additionally, differential flight path reporting being enabled may instruct the UE 502 to store a timestamp associated with the flight path information (e.g., in the last reported flight path buffer). Differential flight path reporting being disabled and/or the optional differentialReporting field not being present in the flight path information request message may instruct the UE 502 to flush and/or clear out the last reported flight path buffer.

In some aspects, the first network node 504 may transmit, as at least part of the flight path information request, a validity duration. For example, the first network node 504 may transmit a differentialFlightPathReportValidityDuration field (e.g., as part of the FlightPathInfoReportConfig IE and/or separately from the FligthPathInfoReportConfig IE) that indicates a time span that is associated with differential flight path reporting and/or baseline flight path information being valid. To illustrate, the UE 502 may calculate a time difference between a current timestamp and a timestamp associated with last reported flight path information. Based at least in part on the time difference being within the validity duration, the UE 502 may report differential flight path information that is based at least in part on the last reported flight path information. Alternatively, or additionally, the UE 502 may flush and/or clear out the last reported flight path buffer and/or may transmit full flight path information based at least in part on the time difference being outside of the validity duration.

As shown by reference number 525, the UE 502 may transmit, and the first network node 504 may receive, UE flight path information. For example, the UE flight path information may include a planned or projected flight path of the UE 502, such as by specifying one or more waypoints and/or one or more timestamps. A waypoint may indicate a planned or projected position of the UE 502, and an associated timestamp may indicate an expected arrival time at the corresponding waypoint. Alternatively, or additionally, the UE flight path information may include a timestamp that indicates a point in time at which the UE flight path information was generated. A waypoint may include and/or indicate the planned or projected position based at least in part on any combination of ellipsoids, polygons, horizontal velocity, and/or vertical velocity. Each indicated waypoint may be associated with a respective position.

In some aspects, the UE flight path information may include full flight path information that includes any combination of one or more absolute waypoints (e.g., absolute location information and/or absolute velocity information), one or more absolute timestamps (e.g., an absolute time), a maximum number of waypoints, and/or a maximum number of timestamps. The maximum number of waypoints and/or the maximum number of timestamps may be RRC configured by the first network node 504 to the UE 502 as described above. The UE 502 may transmit the full flight path information based at least in part on not having an assigned flight path identifier and/or based at least in part on determining that the connection with the first network node 504 is an initial and/or first connection to the first network node 504.

In other aspects, such as described below with regard to reference number 575, the UE flight path information may include differential flight path information that indicates one or more changes that are relative to baseline full flight path information, such as an update to a first waypoint included in the baseline full flight path information, a removal of a second waypoint from the baseline full flight path information, and/or an addition of a third waypoint to the baseline full flight path information. Indicating changes to baseline full flight path information may reduce a first amount of content (e.g., a number of entries) that is included in the differential flight path information relative to a second amount of content that is included in the baseline full flight path information. Reducing an amount of content may reduce overhead associated with maintaining a wireless link between the first network node 504 and the UE 502 and/or may reduce an amount of air interface resources used by the overhead. Reducing air interface resource consumption may result in reduced data transfer latencies within a wireless network, increased capacity by the wireless network (e.g., the wireless network may service more devices), and/or increase data throughput.

Based at least in part on transmitting the UE flight path information, the UE 502 may store the UE flight path information in a last reported flight path buffer that is local to the UE 502. That is, the UE 502 may track and/or record the UE flight path information generated and/or transmitted by the UE 502. Alternatively, or additionally, the UE 502 may store one or more timestamps that are associated with the UE flight path information in the last reported flight path buffer, such as a first timestamp that indicates a first point in time the UE 502 generated the UE flight path information and/or a second timestamp that indicates a second point in time the UE 502 transmitted the UE flight path information (e.g., to the first network node 504).

In some aspects, the UE 502 may transmit, as the UE flight path information, full flight path information based at least in part on the last reported flight path buffer being empty. For instance, the first network node 504 may indicate that differential reporting is enabled as described above, and the UE 502 may determine that the last reported flight path buffer is empty. Accordingly, the UE 502 may transmit full flight path information based at least in part on the last reported flight path buffer being empty. Alternatively, or additionally, the UE 502 may transmit, as the UE flight path information, differential flight path information based at least in part on any combination of validating the last reported flight path information (e.g., via a validity duration) and/or differential reporting being enabled. In some aspects, the UE 502 may flush and/or clear out the last reported flight path buffer, examples of which are provided above.

The UE 502 may transmit the UE flight path information based at least in part on an IE, such as an FlightPathInfoReport IE. As one example, a FlightPathInfoReport may be configured as follows:

```
FlightPathInfoReport ::= SEQUENCE {
  flightPath SEQUENCE (SIZE (1..maxWayPoint)) OF WayPointLocation
  OPTIONAL,
  flightPathDifferential FlightPathDifferential
}
```

where optional field flightPath indicates a sequence and/or array of waypoints (e.g., full flight path information), and optional IE field FlightPathDifferential may indicate differential flight path information. The UE 502 may omit both the optional field flightPath and the optional IE field flightPathDifferential to indicate no change in the flight path information. Alternatively, or additionally, the UE 502 may omit the optional field flightPath based at least in part on including the optional IE field flightPathDifferential to indicate differential flight path information, or may omit the optional IE field flightPathDifferential based at least in part on including the optional field flightPath to indicate full flight path information. Accordingly, the UE 502 may include the optional field flightPath in the FlightPathInfoReport IE based at least in part on transmitting full flight path information, and the UE 502 may include the optional IE field flightPathDifferential to indicate differential flight path information. The FlightPathDifferential IE may be configured as follows:

```
FlightPathDifferential ::= SEQUENCE {/
  updatedNodes SEQUENCE (SIZE (1..maxWayPoint)) OF WayPointLocation
  OPTIONAL,
  deletedNodes SEQUENCE (SIZE (1..maxWayPoint)) OF WayPointLocation
  OPTIONAL
}
```

where the optional field updatedNodes may indicate, as at least part of the differential flight path information, one or more updated waypoints and/or new added waypoints at the UE 502 relative to the last reported flight path information, and the optional field deletedNodes may indicate, as at least part of the differential flight path information, one or more deleted waypoints at the UE 502 relative to the last reported flight path information.

As shown by reference number 530, the first network node 504 may transmit, and a second network node 506 may receive, flight path information. Alternatively, or additionally, the first network node 504 may store the flight path information locally (e.g., in local memory and/or a local last reported flight path buffer). As one example, the first network node 504 may transmit full flight path information that is associated with the UE 502. In some aspects, the first network node 504 may store and/or forward full flight path information received from the UE 502, such as full flight path information transmitted by the UE 502 based at least in part on establishing an initial connection with the first network node 504. Alternatively, or additionally, the first network node 504 may generate the full flight path information (e.g., that is stored locally and/or forwarded to the second network node 506) based at least in part on last reported flight path information and differential flight path information. In some aspects, the first network node 504 may transmit and/or indicate a timestamp that is associated with the UE flight path information, such as a first timestamp received with the UE flight path information (e.g., that indicates a generation time) and/or a second timestamp that indicates a reception time of the UE flight path information (e.g., by the first network node 504).

The first network node 504 may communicate the UE flight path information to the second network node 506 based at least in part on a next generation application protocol (NGAP) procedure associated with the core network. In some aspects, an NGAP may provide one or more signaling services between the first network node 504 and an access and mobility management function (AMF) at the second network node 506. Example Class 1 NGAP procedures may include any combination of an AMF configuration update procedure, a RAN configuration update procedure, a handover (HO) preparation procedure, and/or an HO resource allocation procedure. Example Class 2 NGAP procedures may include a downlink RAN configuration transfer procedure, a downlink RAN status transfer procedure, and/or a downlink non-access stratum (NAS) transport procedure. In some aspects, the NGAP may include a UE flight path management procedure, and the UE flight path management procedure may be an NGAP procedure that is based at least in part on, and/or communicates with, an AMF at the second network node 506. The second network node 506 and/or the AMF at the second network node 506 may store the flight path information as prior flight path information.

Alternatively, or additionally the second network node 506 may store, and/or the first network node 504 may retrieve, the flight path information based at least in part on one or more context management procedures. To illustrate, during an initial context setup management procedure (e.g., a setup request), the second network node 506, by way of an AMF, may indicate support for providing flight path related information as at least part of context information to the first network node 504, and, in a setup response, the first network node 504 may indicate the flight path information, such as one or more waypoints, differential waypoint information, and/or a timestamp. At a later point in time, such as that described with regard to reference number 560 and reference number 565 below, the first network node 504 may transmit a retrieve UE information message to the second network node 506 and/or initiate a retrieve UE information procedure with the second network node 506 to obtain flight path information stored by the AMF, and the second network node 506 may transmit the flight path information based at least in part on a UE information transfer message and/or a UE information transfer procedure.

While the example 500 includes the first network node 504 transmitting flight path information to the second network node 506, other examples may exclude the first network node 504 transmitting the flight path information to the second network node 506. For example, as described above, the first network node 504 may store the flight path information locally as described above and, in some aspects, may not transmit the flight path information to the second network node 506.

As shown by reference number 535, the second network node 506 may transmit, and the first network node 504 may receive, a flight path identifier that is associated with the UE 502. In some aspects, the second network node 506 may indicate the flight path identifier as a new flight path identifier to assign to the UE 502. That is, the second network node 506 may determine, based at least in part on receiving the flight path information as described with regard to reference number 530, that the UE 502 does not have an assigned flight path identifier. For example, the flight plan information may not include a flight path identifier, and the second network node 506 may determine to assign a flight path identifier to the UE 502. The second network node 506 may store the flight path identifier with the prior flight path information.

As shown by reference number 540, the first network node 504 may transmit, and the UE 502 may receive, the flight path identifier. As one example, the first network node 504 may indicate the flight path identifier to the UE 502 based at least in part on an uncrewed aerial vehicle uncrewed aerial system service supplier authorization and/or authentication (UUAA) procedure and/or UUAA process. Alternatively, or additionally, the first network node 504 may store the flight path identifier locally (e.g., in memory and/or a buffer associated with last reported flight path information).

As shown by reference number 545, a time span may occur and, at a point in time within the time span, the UE 502 and the first network node 504 may disconnect from one another. As one example, the UE 502 may transition to an idle mode and/or disconnect from the first network node 504 based at least in part on experiencing a radio link failure (RLF). The UE 502 may identify the RLF based at least in part on one or more signal metrics (e.g., RSSI and/or RSRP) failing to satisfy a quality threshold. Accordingly, the UE 502 and the first network node 504 may disconnect from one another.

As shown by reference number 550, the first network node 504 may transmit, and the UE 502 may receive, an indication of a flight path capability supported by the first network node 504 as described with regard to reference number 510, such as by broadcasting an indication of the flight path capability in SI. However, in other examples, the first network node 504 may indicate the flight path capability, a flight path capability configuration, and/or different flight path configuration information in a unicast message and based at least in part on establishing a connection with the UE 502.

The first network node 504 may transmit, with the flight path capability, a flight path capability configuration, such as a current state of the flight path capability. Alternatively, or additionally, the first network node 504 may indicate differential flight path configuration information that specifies a trigger event for autonomous and/or asynchronous reporting of differential flight path information. For instance, the differential flight path configuration information may indicate any combination of a location change threshold, a time change threshold, a lateral position change threshold, a longitudinal position change threshold, and/or an altitude change threshold. In some aspects, the first network node 504 may indicate a validity duration that is associated with validating differential flight path information.

As shown by reference number 555, the UE 502 and the first network node 504 may reestablish a connection and/or establish a new connection and/or may reestablish a communication link (e.g., a wireless link). For visual clarity, FIG. 5 shows the UE 502 reestablishing a connection with the first network node 504, but in other examples, the UE 502 may establish a connection with a different network node than the first network node 504 (e.g., the UE 502 may establish a connection with a third network node), and the UE 502 may transmit the flight path identifier to the different network node. In some aspects, and based at least in part on establishing a connection with the first network node 504 (and/or a different network node), the UE 502 may transmit, and the first network node 504 may receive, a flight path identifier, such as the flight path identifier received by the UE 502 as described with regard to reference number 540.

As shown by reference number 560, the first network node 504 may transmit, and the second network node 506 may receive, a flight path query. In some aspects, the first network node 504 may communicate, as at least part of the flight path query, the flight path identifier received from the UE 502. The transmission of a flight path query and/or the indication of a flight path identifier may explicitly and/or implicitly request stored flight path information from an AMF at the second network node 506, such as prior flight path information that is stored by the AMF and is associated with the flight path identifier, such as the flight path information as described with regard to reference number 530.

Alternatively, or additionally, the first network node 504 may request the stored flight path information based at least in part on a setup request procedure and a setup response procedure. In some aspects, the first network node 504 may request the stored flight path information based at least in part on a retrieve UE information procedure and a UE information transfer procedure. Accordingly, the flight path query may be based at least in part on the setup request procedure and/or the UE information transfer procedure.

While the example 500 includes the first network node 504 requesting the stored flight path information from the second network node 506, other examples may exclude the first network node 504 requesting the stored flight path information from the second network node 506. For example, the first network node 504 may store flight path information locally as described above, and may obtain the flight path information associated with the UE 502 locally and based at least in part on a flight path identifier received from the UE 502.

As shown by reference number 565, the second network node 506 may transmit, and the first network node 504 may receive, a response to the flight path query. In some aspects, the response from the second network node 506 may include prior UE flight path information (e.g., flight path information from the UE 502 that is stored at the second network node 506) and/or a timestamp that is associated with the prior UE flight path information. For instance, the second network node 506 may obtain the prior UE flight path information based at least in part on retrieving the prior UE flight path information from an AMF at the second network node 506. In some aspects, the second network node 506 may select the prior flight path information based at least in part on receiving the flight path identifier as at least part of the flight path query. Accordingly, the prior UE flight path information may be based at least in part on the last reported UE flight path information associated with the UE 502. In some aspects, the response to the flight path query may be based at least in part on a setup response procedure and/or a UE information transfer procedure.

While the example 500 includes the first network node 504 receiving the response to the flight path query from the second network node 506, other examples may exclude the first network node 504 receiving the response from the second network node 506. For example, the first network node 504 may store flight path information locally as described above, and obtain the flight path information associated with the UE 502 locally and based at least in part on a flight path identifier received from the UE 502. Accordingly, and based at least in part on not transmitting a flight path query, the first network node 504 may not receive a response.

As shown by reference number 570, the first network node 504 may transmit, and the UE 502 may receive, a flight path information request. For example, the first network node 504 may transmit the flight path information request based at least in part on an UEInformationRequest IE and/or a FlightPathInfoReportConfig IE as described above. In some aspects, the flight path information request may be based at least in part on the response to the flight path query. Alternatively, or additionally, the flight path information request may include a timestamp that is associated with the prior UE flight path information (e.g., indicated by the second network node 506 as described with regard to reference number 565 and/or indicated the UE 502 as described with regard to reference number 525). The first network node 504 may transmit the flight path information based at least in part on establishing a connection with the UE 502 and/or using a unicast message.

As shown by reference number 575, the UE 502 may transmit, and the first network node 504 may receive, UE flight path information. For instance, the UE 502 may transmit the UE flight path information based at least in part on receiving the flight path information request. Accordingly, the UE flight path information may be transmitted as at least part of a flight path information request response. The UE 502 may transmit the UE flight path information and/or the flight path information request response based at least in part on an IE, such as a FlightPathInfoReport IE as described above. In some aspects, the UE 502 may transmit, as the UE flight path information, full flight path information. To illustrate, the UE 502 may determine that a validity duration indicated by the first network node 504 has expired, such by determining that a time difference fails to satisfy the validity duration, and, based at least in part on the validity duration being expired, the UE 502 may determine that transmitting differential flight path information is invalid. Accordingly, the UE 502 may transmit full flight path information and/or may update a last reported flight path buffer and/or store the full flight path information in the last reported flight path buffer. Alternatively, or additionally, the UE 502 may store a timestamp in the last reported flight path buffer as described above. In some aspects, to update the last reported flight path buffer, the UE 502 may remove expired flight path information that is stored in the last reported flight path buffer and/or overwrite the expired flight path information.

Alternatively, or additionally, the UE 502 may transmit, as the UE flight path information, differential flight path information. For instance, the UE 502 may determine that the differential flight path information is valid based at least in part on a time difference satisfying a validity duration. Accordingly, the UE 502 may transmit the differential flight path information based at least in part on determining that the differential flight path information is valid. The UE 502 may transmit a flight path identifier with the UE flight path information, including full flight path information and/or differential flight path information.

The UE 502 may generate the differential flight path information based at least in part on comparing a current waypoint to a prior waypoint, such as a prior waypoint that is stored in the last reported flight path buffer and/or a prior waypoint that is associated with a timestamp indicated by the first network node 504 in a flight path information request. The UE may evaluate and/or compare the current waypoint to the prior waypoint in a variety of manners, such as by calculating a change and/or difference between a property of the current waypoint to a respective property of the prior waypoint and determining whether the change and/or difference satisfies a differential threshold. The differential threshold may be based at least in part on the differential flight path information configuration as described above. Some examples may include the UE 502 evaluating a location change, a longitude change, a latitude change, and/or a time difference between the current waypoint and the prior waypoint.

The UE 502 may include, in the differential flight path information, an indication of a change that satisfies the differential threshold. For example, the differential flight path information may indicate any combination of an update to a first waypoint included in prior UE flight path information (e.g., stored in the last reported flight path buffer), a removal of a second waypoint from the prior UE flight path information, and/or an addition of a third waypoint to the prior UE flight path information. Alternatively, or additionally, the UE 502 may indicate, with the differential flight path information, a timestamp that is associated with the differential flight path information. For example, the UE 502 may select the prior full flight path information based at least in part on the first timestamp (e.g., indicated based at least in part on optional field timeStampofLastReportedFlightPath as described above) and/or may select the prior full flight path information as full flight path information stored in a last reported flight path buffer. The UE 502 may generate and/or calculate the differential flight path information at a second point in time (e.g., a current time), and may indicate the second point in time as a second timestamp. Accordingly, the UE 502 may indicate the second timestamp with the differential flight path information.

The following pseudo code provides an example FindDifferentialFlightPath algorithm that may be implemented by the UE 502 to calculate differential flight path information:

```
Input: FP(t), FP(t′), t
Return: updatedNodes, deletedNodes
BEGIN
updatedNodes = [ ]
retainedNodes = [ ]
For w′ = (x′, τ′) ∈ FP(t′)
  isNewNode = FALSE
  For w = (x, τ) ∈ FP(t)
    if ||x − x′|| > Δx AND |τ − τ′| > Δt
      isNewNode = TRUE
    Else
      retainedNodes ← w
    isNewNode = FALSE
    Endif
  endFor
  If isNewNode
    updatedNodes ← w′
  endIf
endFor
deletedNodes = FP(t) \retainedNodes
END
```

where FP(t) represents a FindDifferentialFlightPath algorithm at time=t. The notation FP(t)={w} indicates that the flight path information query algorithm returns {w}, where w is a waypoint that may be represented as w=(x, τ), x denotes a location that characterizes the waypoint, and τ denotes a time that characterizes the waypoint (which may be optional). The variables updatedNodes=[ ] and retainedNodes=[ ] represent respective arrays of waypoints.

In the above pseudo code, Δx and Δτ may each represent a respective change threshold such as one or more change thresholds indicated by the first network node 504. For discussion purposes, Δx and Δτ are shown as a location change threshold and a time change threshold, respectively, in the pseudo code, but other combinations of change thresholds may be included and/or omitted by the UE 502 as part of a FindDifferentialFlightPath algorithm, examples of which are provided above.

In some aspects, the UE 502 may execute the FindDifferentialFlightPath algorithm at time t′. As shown by the pseudo code, the UE 502 may compare one or more waypoints of a current flight path (denoted as w′) calculated by the UE 502 with one or more previously reported waypoints (denoted as w). To illustrate, the UE 502 may compare a first time that is associated with the current waypoint (denoted as τ′) with a second time that is associated with a last reported waypoint (denoted as τ) based at least in part on a time change threshold. Alternatively, or additionally, the UE 502 may compare a first location that is associated with the current waypoint (denoted as x′) with a second location that is associated with a last reported waypoint (denoted as x) based at least in part on a location change threshold. The UE 502 may determine whether to update the waypoint, add the waypoint, and/or remove the waypoint as part of the differential flight path information based at least in part on the comparison and whether a change threshold has been satisfied. Alternatively, or additionally, UE 502 may indicate no change to the waypoint based at least in part on omitting the waypoint from the differential flight path information based at least in part on the comparison to a change threshold.

The UE 502 may compare each waypoint included in current flight path information to each waypoint included in the last reported flight path information as shown through the use of a for loop, may add and/or update a waypoint as part of the differential flight path information as shown through the use of an if-else statement, and/or may remove a waypoint as part of the differential flight path information through the use of the if-else statement.

In some aspects, the UE 502 may transmit, as the UE flight path information, a flight path information request response that indicates no change to UE flight path information. For instance, the UE 502 may determine that no change and/or difference satisfies the differential threshold. Accordingly, the UE 502 may indicate no change to the UE flight path information as described above.

As shown by reference number 580, the first network node 504 may transmit, and the second network node 506 may receive, flight path information. As a first example, the first network node 504 may communicate differential flight path information received from the UE 502 (e.g., as UE flight path information). As a second example, the first network node 504 may communicate full flight path information to the second network node 506 that is based at least in part on the UE flight path information. For instance, the first network node 504 may receive differential flight path information from the UE 502, and may generate the full flight path information based at least in part on the response from the second network node 506 (e.g., that indicates prior UE flight path information) and the differential flight path information from the UE 502. Alternatively, or additionally, the first network node 504 may communicate full flight path information that is received from the UE 502. In some aspects, the first network node 504 may communicate the flight path information to the second network node 506 based at least in part on an NGAP procedure as described above. Alternatively, or additionally, the first network node 504 may communicate, with the flight path information (e.g., full flight path information and/or differential flight path information) a timestamp that is associated with generation of the flight path information, such as a timestamp indicated by the UE 502 and/or a timestamp captured by the first network node 504. Based at least in part on receiving the flight path information, the second network node 506 and/or an AMF at the second network node 506 may store the flight path information and/or a timestamp associated with the flight path information as prior flight path information.

While the example 500 includes the first network node 504 transmitting flight path information to the second network node 506, other examples may exclude the first network node 504 transmitting the flight path information to the second network node 506. For example, as described above, the first network node 504 may store the flight path information locally as described above and, in some aspects, may not transmit the flight path information to the second network node 506.

Differential flight path information may reduce overhead signaling that is associated with maintaining a wireless link between the network node and the UAV and, subsequently, may reduce an amount of air interface resources used by the overhead signaling. Reducing air interface resource consumption may result in reduced data transfer latencies within a wireless network, increased capacity by the wireless network (e.g., the wireless network may service more devices), and/or increase data throughput.

As indicated above, FIG. 5 is provided as an example. Other examples may differ from what is described with regard to FIG. 5.

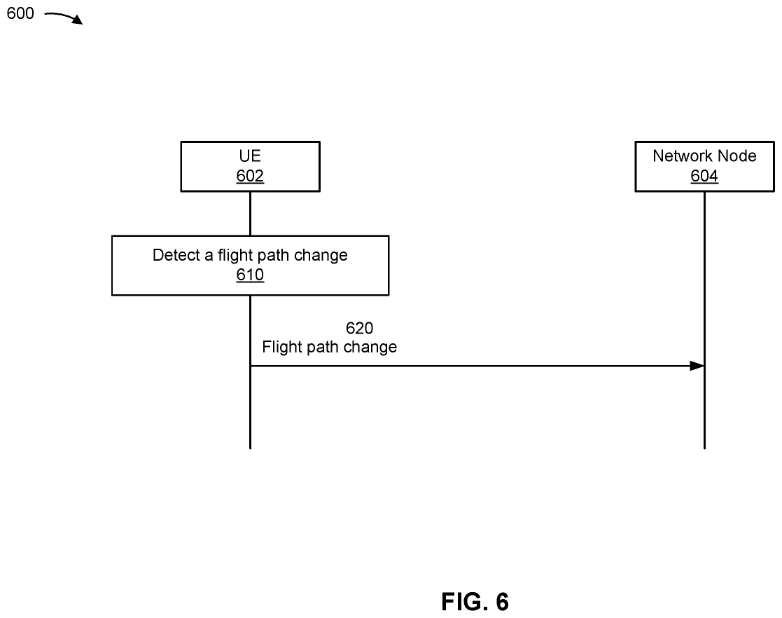

FIG. 6 is a diagram illustrating an example 600 of a wireless communication process between a UE 602 (e.g., a UE 120 and/or the UE 502) and a network node 604 (e.g., a network node 110 and/or the first network node 504), in accordance with the present disclosure. Aspects of the wireless communication process described with regard to the example 600 may be combines with aspects of the wireless communication process described with regard to the example 500.

As shown by reference number 610, a UE 602 may detect a flight path change. In some aspects, the UE 602 may detect the UE flight path change based at least in part on last reported UE flight path information. For instance, and as described with regard to FIG. 5, the UE 602 may receive an indication of one or more change thresholds from a network node 604, and the UE 6-2 may use the change threshold(s) to detect a change between current flight path information and last reported UE flight path information.

As shown by reference number 620, the UE 602 may transmit, and a network node 604 may receive, a flight path change indication. In some aspects, the UE 602 may transmit the flight path change indication based at least in part on detecting the UE flight path change and/or based at least in part on receiving an indication that the network node 604 supports the differential flight path information.

As one example, the UE 602 may transmit the flight path change indication in a MAC CE. In some aspects, the flight path change indication may specify that updated flight path information is available. As another example, the UE 602 may initiate and/or transmit a UE assistance information message (e.g., a UEAssistanceInformation message) that indicates that updated flight path information is available. Based at least in part on receiving the flight path change indication, the network node 604 may determine whether to transmit a flight path information request as described with regard to reference number 530 and reference number 570 of FIG. 5. That is, the network node 604 may transmit, and the UE 602 may receive, a flight path information request message that is associated with retrieving the updated flight path information and/or current UE flight path information.

Alternatively, or additionally, the UE 602 may indicate current UE flight path information (e.g., full flight path information and/or differential flight path information) as at least part of the flight path change indication (e.g., the UE flight path change). In some aspects, the UE 602 may indicate the current UE flight path information autonomously and without receiving a flight path information request from the network node 604. For instance, the UE 602 may trigger and/or initiate transmission of a UE information response message (e.g., a UEInformationResponse Message Without Request) and may indicate, in the UE information response message, the current UE flight path information. As described above, the UE 602 may indicate the current UE flight path information based at least in part on indicating full flight path information and/or by indicating differential flight path information. However, in other aspects, the UE 602 may transmit and/or indicate the current UE flight path information based at least in part on receiving a request from the network node 604.

As indicated above, FIG. 6 is provided as an example. Other examples may differ from what is described with regard to FIG. 6.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with reduced flight path reporting overhead.

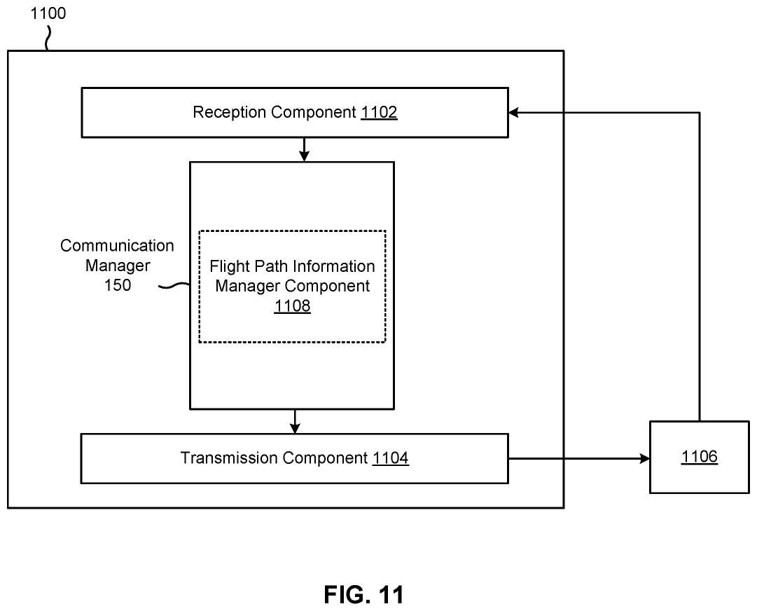

As shown in FIG. 7, in some aspects, process 700 may include transmitting a flight path information request that indicates a differential flight path reporting configuration that is associated with UE flight path information associated with a UE (block 710). For example, the network node (e.g., using communication manager 150 and/or transmission component 1104, depicted in FIG. 11) may transmit a flight path information request that indicates a differential flight path reporting configuration that is associated with UE flight path information associated with a UE, as described above.

As further shown in FIG. 7, in some aspects, process 700 may include receiving the UE flight path information, the UE flight path information being based at least in part on the differential flight path reporting configuration (block 720). For example, the network node (e.g., using communication manager 150 and/or reception component 1102, depicted in FIG. 11) may receive the UE flight path information, the UE flight path information being based at least in part on the differential flight path reporting configuration, as described above.

Process 700 may include additional aspects, such as any single aspect or any combination of aspects described below and/or in connection with one or more other processes described elsewhere herein.

In a first aspect, process 700 includes communicating, to a core network, a flight path query that is associated with the UE, and receiving, from the core network, a response to the flight path query, and the flight path information request is based at least in part on the response from the core network.

In a second aspect, process 700 includes communicating full flight path information to the core network, and the full flight path information is based at least in part on the UE flight path information.

In a third aspect, the UE flight path information comprises the full flight path information.

In a fourth aspect, the UE flight path information comprises differential flight path information, and process 700 includes generating the full flight path information based at least in part on the response from the core network and the differential flight path information.

In a fifth aspect, the response from the core network includes prior UE flight path information, and the differential flight path information indicates at least one of an update to a first waypoint included in the prior UE flight path information, a removal of a second waypoint from the prior UE flight path information, or an addition of a third waypoint to the prior UE flight path information.

In a sixth aspect, the response from the core network includes prior UE flight path information that is associated with the UE and a first time stamp associated with the prior UE flight path information, the differential flight path information is based at least in part on the first time stamp and a second time stamp, and generating the full flight path information is based at least in part on the prior UE flight path information and the differential flight path information.

In a seventh aspect, process 700 includes transmitting an indication that indicates support for differential flight path information.

In an eighth aspect, the indication indicates that differential flight path support is enabled.

In a ninth aspect, transmitting the indication includes broadcasting the indication in system information.

In a tenth aspect, the indication is a first indication, and process 700 includes transmitting a second indication of a validity duration that is associated with validating differential flight path information.

In an eleventh aspect, the flight path information request includes a timestamp that is based at least in part on prior UE flight path information.

In a twelfth aspect, process 700 includes receiving the timestamp from a core network.

In a thirteenth aspect, process 700 includes receiving the timestamp from the UE with the prior UE flight path information.

In a fourteenth aspect, process 700 includes receiving, from the UE, a flight path information request response that indicates no change to UE flight path information.

In a fifteenth aspect, process 700 includes receiving, from the UE, a flight path identifier, communicating the flight path identifier to a core network, and receiving, from the core network, UE flight path information that is based at least in part on the flight path identifier.

In a sixteenth aspect, the flight path information request includes a time stamp associated with prior UE flight path information associated with the UE.

In a seventeenth aspect, the prior UE flight path information is based at least in part on last reported UE flight path information associated with the UE.

In an eighteenth aspect, process 700 includes receiving the last reported UE flight path information from a core network.

In a nineteenth aspect, process 700 includes receiving the last reported UE flight path information from the UE and prior to transmitting the flight path information request.

In a twentieth aspect, process 700 includes transmitting differential flight path configuration information.

In a twenty-first aspect, the differential flight path configuration information includes at least one of a location change threshold, a time change threshold, a lateral position change threshold, a longitudinal position change threshold, or an altitude change threshold.

In a twenty-second aspect, transmitting the differential flight path configuration information includes broadcasting the differential flight path configuration information in system information.

In a twenty-third aspect, transmitting the differential flight path configuration information includes transmitting the differential flight path configuration information in a unicast message.

In a twenty-fourth aspect, process 700 includes communicating the UE flight path information to a core network based at least in part on an NGAP procedure associated with the core network.

In a twenty-fifth aspect, the NGAP procedure includes a UE flight path management procedure.

In a twenty-sixth aspect, process 700 includes communicating, to the core network, a time stamp associated with generation of the UE flight path information.

In a twenty-seventh aspect, the NGAP procedure is based at least in part on an AMF at the core network.

In a twenty-eighth aspect, process 700 includes receiving, from the core network, a flight plan identifier associated with the UE, and communicating the flight plan identifier to the UE.

In a twenty-ninth aspect, process 700 includes requesting stored flight path information from an AMF at a core network, and receiving, as a response from the core network, the stored flight path information based at least in part on the AMF at the core network.

In a thirtieth aspect, requesting the stored flight path information includes requesting the stored flight path information based at least in part on a setup request procedure and a setup response procedure.

In a thirty-first aspect, requesting the stored flight path information includes requesting the stored flight path information based at least in part on a retrieve UE information procedure and a UE information transfer procedure.

In a thirty-second aspect, process 700 includes receiving, from the UE and as the UE flight path information, differential flight path information, and communicating the differential flight path information to a core network.

In a thirty-third aspect, process 700 includes storing the UE flight path information locally.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with reduced flight path reporting overhead.

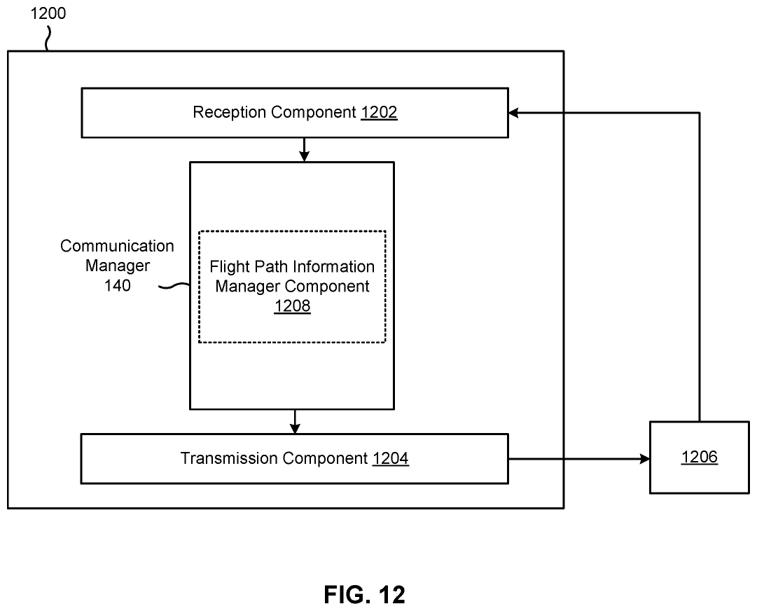

As shown in FIG. 8, in some aspects, process 800 may include receiving an indication that indicates that a network node supports differential flight path information (block 810). For example, the UE (e.g., using communication manager 140 and/or reception component 1202, depicted in FIG. 12) may receive an indication that indicates that a network node supports differential flight path information, as described above.

As further shown in FIG. 8, in some aspects, process 800 may include receiving a flight path information request from the network node (block 820). For example, the UE (e.g., using communication manager 140 and/or reception component 1202, depicted in FIG. 12) may receive a flight path information request from the network node, as described above.

As further shown in FIG. 8, in some aspects, process 800 may include transmitting a response to the flight path information request that is based at least in part on the network node supporting the differential flight path information (block 830). For example, the UE (e.g., using communication manager 140 and/or transmission component 1204, depicted in FIG. 12) may transmit a response to the flight path information request that is based at least in part on the network node supporting the differential flight path information, as described above.

Process 800 may include additional aspects, such as any single aspect or any combination of aspects described below and/or in connection with one or more other processes described elsewhere herein.

In a first aspect, transmitting the response includes transmitting UE flight path information based at least in part on receiving the flight path information request, and process 800 includes updating a last reported flight path buffer based at least in part on the UE flight path information.

In a second aspect, the UE flight path information includes full flight path information.

In a third aspect, process 800 includes determining that the differential flight path information is invalid based at least in part on a validity duration, and transmitting the UE flight path information includes transmitting the full flight path information based at least in part on determining that the differential flight path information is invalid.

In a fourth aspect, updating the last reported flight path buffer includes removing stored flight path information from the last reported flight path buffer.

In a fifth aspect, process 800 includes storing the full flight path information in the last reported flight path buffer.

In a sixth aspect, the UE flight path information includes the differential flight path information.

In a seventh aspect, process 800 includes determining that the differential flight path information is valid based at least in part on a validity duration, and transmitting the UE flight path information includes transmitting, as the UE flight path information, the differential flight path information based at least in part on determining that the differential flight path information is valid.

In an eighth aspect, the differential flight path information indicates at least one of an update to a first waypoint included in prior UE flight path information, a removal of a second waypoint from the prior UE flight path information, or an addition of a third waypoint to the prior UE flight path information.

In a ninth aspect, process 800 includes generating the differential flight path information based at least in part on comparing a current waypoint to a prior waypoint.

In a tenth aspect, comparing the current waypoint to the prior waypoint includes determining whether a change between the current waypoint and the prior waypoint satisfies a differential threshold.

In an eleventh aspect, the change includes at least one of a location change, or a time difference between the current waypoint and the prior waypoint.

In a twelfth aspect, updating the last reported flight path buffer includes storing a time stamp associated with the UE flight path information in the last reported flight path buffer.

In a thirteenth aspect, the indication indicates that differential flight path support is enabled.

In a fourteenth aspect, receiving the indication includes receiving the indication in system information.

In a fifteenth aspect, the indication is a first indication, and process 800 includes receiving a second indication of a validity duration that is associated with validating the differential flight path information.

In a sixteenth aspect, the flight path information request includes a timestamp that is based at least in part on prior UE flight path information associated with the UE.

In a seventeenth aspect, receiving the flight path information request includes receiving the flight path information request based at least in part on a unicast message.

In an eighteenth aspect, process 800 includes transmitting a flight path information request response that indicates no change to UE flight path information.

In a nineteenth aspect, process 800 includes transmitting a flight path information request response that includes a flight path identifier.

In a twentieth aspect, process 800 includes receiving, from the network node, the flight path identifier based at least in part on a UUAA procedure.

In a twenty-first aspect, the flight path information request includes a time stamp associated with prior UE flight path information.

In a twenty-second aspect, the prior UE flight path information is based at least in part on last reported UE flight information associated with the UE.

In a twenty-third aspect, process 800 includes receiving differential flight path configuration information.

In a twenty-fourth aspect, the differential flight path configuration information includes at least one of a location change threshold, a time change threshold, a lateral position change threshold, a longitudinal position change threshold, or an altitude change threshold.

In a twenty-fifth aspect, receiving the differential flight path configuration information includes receiving the differential flight path configuration information in system information.

In a twenty-sixth aspect, receiving the differential flight path configuration information includes receiving the differential flight path configuration information in a unicast message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with reduced flight path reporting overhead.

As shown in FIG. 9, in some aspects, process 900 may include detecting a UE flight path change that satisfies a threshold (block 910). For example, the UE (e.g., using communication manager 140 and/or flight path information manager component 1208, depicted in FIG. 12) may detect a UE flight path change that satisfies a threshold, as described above.

As further shown in FIG. 9, in some aspects, process 900 may include transmitting a flight path change indication to a network node (block 920). For example, the UE (e.g., using communication manager 140 and/or transmission component 1204, depicted in FIG. 12) may transmit a flight path change indication to a network node, as described above.

Process 900 may include additional aspects, such as any single aspect or any combination of aspects described below and/or in connection with one or more other processes described elsewhere herein.

In a first aspect, the UE flight path change is based at least in part on last reported UE flight path information.

In a second aspect, transmitting the flight path change indication includes transmitting the flight path change indication in a MAC CE.

In a third aspect, transmitting the flight path change indication includes transmitting the flight path change indication in a UE assistance information message.

In a fourth aspect, process 900 includes transmitting current UE flight path information that indicates the UE flight path change.

In a fifth aspect, the current UE flight path information includes full flight path information, or differential flight path information.

In a sixth aspect, process 900 includes receiving a flight path information request from the network node, and transmitting the current UE flight path information is based at least in part on receiving the flight path information request from the network node.

In a seventh aspect, transmitting the current UE flight path information includes autonomously transmitting the current UE flight path information.

In an eighth aspect, process 900 includes receiving an indication that indicates that the network node supports differential flight path information, and transmitting the flight path change indication is based at least in part on receiving the indication that the network node supports the differential flight path information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with reduced flight path reporting overhead.

As shown in FIG. 10, in some aspects, process 1000 may include receiving, from a UE, last reported UE flight path information (block 1010). For example, the network node (e.g., using communication manager 150 and/or reception component 1102, depicted in FIG. 11) may receive, from a UE, last reported UE flight path information, as described above.

As further shown in FIG. 10, in some aspects, process 1000 may include receiving, without transmitting a flight path information request and from the UE, a flight path change indication that is associated with a UE flight path change (block 1020). For example, the network node (e.g., using communication manager 150 and/or reception component 1102, depicted in FIG. 11) may receive, without transmitting a flight path information request and from the UE, a flight path change indication that is associated with a UE flight path change, as described above.

Process 1000 may include additional aspects, such as any single aspect or any combination of aspects described below and/or in connection with one or more other processes described elsewhere herein.

In a first aspect, the UE flight path change is based at least in part on the last reported UE flight path information.

In a second aspect, receiving the flight path change indication includes receiving the flight path change indication in a MAC CE.

In a third aspect, receiving the flight path change indication includes receiving the flight path change indication in a UE assistance information message.

In a fourth aspect, process 1000 includes receiving current UE flight path information that includes the flight path change indication.

In a fifth aspect, the current UE flight path information includes full flight path information, or differential flight path information.

In a sixth aspect, process 1000 includes transmitting the flight path information request to the UE based at least in part on receiving the flight path change indication, and receiving the current UE flight path information is based at least in part on receiving the flight path information request from the network node.

In a seventh aspect, receiving the current UE flight path information includes autonomously receiving the current UE flight path information without transmitting the flight path information request.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include one or more of a flight path information manager component 1108, among other examples.

In some aspects, the apparatus 1100 may be configured to perform one or more operations described herein in connection with FIGS. 4-10. Additionally, or alternatively, the apparatus 1100 may be configured to perform one or more processes described herein, such as process 700 of FIG. 7, process 1000 of FIG. 10, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The transmission component 1104 may transmit a flight path information request that indicates a differential flight path reporting configuration that is associated with UE flight path information associated with a UE. The reception component 1102 may receive the UE flight path information, the UE flight path information being based at least in part on the differential flight path reporting configuration.

The flight path information manager component 1108 may communicate, to a core network, a flight path query that is associated with the UE. Alternatively, or additionally, the reception component 1102 may receive, from the core network, a response to the flight path query, and the flight path information request is based at least in part on the response from the core network. In some aspects, the flight path information manager component 1108 may communicate full flight path information to the core network, and the full flight path information is based at least in part on the UE flight path information.

The transmission component 1104 may transmit an indication that indicates support for differential flight path information. Alternatively, or additionally, the reception component 1102 may receive the timestamp from a core network. In some aspects, the reception component 1102 may receive the timestamp from the UE with the prior UE flight path information.

The reception component 1102 may receive, from the UE, a flight path information request response that indicates no change to UE flight path information. Alternatively, or additionally, the reception component 1102 may receive, from the UE, a flight path identifier. The flight path information manager component 1108 may communicate the flight path identifier to a core network. In some aspects, the reception component 1102 may receive, from the core network, UE flight path information that is based at least in part on the flight path identifier.

The reception component 1102 may receive the last reported UE flight path information from a core network. In some aspects, the reception component 1102 may receive the last reported UE flight path information from the UE and prior to transmitting the flight path information request. Alternatively, or additionally, the transmission component 1104 may transmit differential flight path configuration information.

The flight path information manager component 1108 may communicate the UE flight path information to a core network based at least in part on an NGAP procedure associated with the core network. Alternatively, or additionally, the flight path information manager component 1108 may communicate, to the core network, a time stamp associated with generation of the UE flight path information. In some aspects, the reception component 1102 may receive, from the core network, a flight plan identifier associated with the UE. The flight path information manager component 1108 may communicate the flight plan identifier to the UE.

The flight path information manager component 1108 may request stored flight path information from an AMF at a core network. Alternatively, or additionally, the reception component 1102 may receive, as a response from the core network, the stored flight path information based at least in part on the AMF at the core network.

The reception component 1102 may receive, from the UE and as the UE flight path information, differential flight path information. In some aspects, the flight path information manager component 1108 may communicate the differential flight path information to a core network. Alternatively, or additionally, the flight path information manager component 1108 may store the UE flight path information locally.

The reception component 1102 may receive, from a UE, last reported UE flight path information. The reception component 1102 may receive, without transmitting a flight path information request and from the UE, a flight path change indication that is associated with a UE flight path change. In some aspects, the reception component 1102 may receive current UE flight path information that includes the flight path change indication. The transmission component 1104 may transmit the flight path information request to the UE based at least in part on receiving the flight path change indication, and receiving the current UE flight path information is based at least in part on receiving the flight path information request from the network node.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of a flight path information manager component 1208, among other examples.

In some aspects, the apparatus 1200 may be configured to perform one or more operations described herein in connection with FIGS. 4-10. Additionally, or alternatively, the apparatus 1200 may be configured to perform one or more processes described herein, such as process 800 of FIG. 8, process 900 of FIG. 9, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1204 may be co-located with the reception component 1202 in one or more transceivers.

The reception component 1202 may receive an indication that indicates that a network node supports differential flight path information. The reception component 1202 may receive a flight path information request from the network node. The transmission component 1204 may transmit a response to the flight path information request that is based at least in part on the network node supporting the differential flight path information.

The flight path information manager component 1208 may determine that the differential flight path information is invalid based at least in part on a validity duration. Alternatively, or additionally, the flight path information manager component 1208 may store the full flight path information in the last reported flight path buffer. In some aspects, the flight path information manager component 1208 may determine that the differential flight path information is valid based at least in part on a validity duration. The flight path information manager component 1208 may generate the differential flight path information based at least in part on comparing a current waypoint to a prior waypoint.

The transmission component 1204 may transmit a flight path information request response that indicates no change to UE flight path information. Alternatively, or additionally, the transmission component 1204 may transmit a flight path information request response that includes a flight path identifier. In some aspects, the reception component 1202 may receive, from the network node, the flight path identifier based at least in part on a UUAA procedure.

The reception component 1202 may receive differential flight path configuration information. Alternatively, or additionally, the flight path information manager component 1208 may detect a UE flight path change that satisfies a threshold. The transmission component 1204 may transmit a flight path change indication to a network node. In some aspects, the transmission component 1204 may transmit current UE flight path information that indicates the UE flight path change.

The reception component 1202 may receive a flight path information request from the network node, and transmitting the current UE flight path information is based at least in part on receiving the flight path information request from the network node. Alternatively, or additionally, the reception component 1202 may receive an indication that indicates that the network node supports differential flight path information, and transmit the flight path change indication based at least in part on receiving the indication that the network node supports the differential flight path information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by an apparatus of a network node, comprising: transmitting a flight path information request that indicates a differential flight path reporting configuration that is associated with user equipment (UE) flight path information associated with a UE; and receiving the UE flight path information, the UE flight path information being based at least in part on the differential flight path reporting configuration.

Aspect 2: The method of Aspect 1, further comprising: communicating, to a core network, a flight path query that is associated with the UE; and receiving, from the core network, a response to the flight path query, wherein the flight path information request is based at least in part on the response from the core network.

Aspect 3: The method of Aspect 2, further comprising: communicating full flight path information to the core network, wherein the full flight path information is based at least in part on the UE flight path information.

Aspect 4: The method of Aspect 3, wherein the UE flight path information comprises the full flight path information.

Aspect 5: The method of Aspect 3, wherein the UE flight path information comprises differential flight path information, and the method further comprises: generating the full flight path information based at least in part on the response from the core network and the differential flight path information.

Aspect 6: The method of Aspect 5, wherein the response from the core network includes prior UE flight path information, and wherein the differential flight path information indicates at least one of: an update to a first waypoint included in the prior UE flight path information, a removal of a second waypoint from the prior UE flight path information, or an addition of a third waypoint to the prior UE flight path information.

Aspect 7: The method of Aspect 5 or Aspect 6, wherein the response from the core network includes prior UE flight path information that is associated with the UE and a first time stamp associated with the prior UE flight path information, wherein the differential flight path information is based at least in part on the first time stamp and a second time stamp, and wherein generating the full flight path information is based at least in part on the prior UE flight path information and the differential flight path information.

Aspect 8: The method of any of Aspects 1-7, further comprising: transmitting an indication that indicates support for differential flight path information.

Aspect 9: The method of Aspect 8, wherein the indication indicates that differential flight path support is enabled.

Aspect 10: The method of Aspect 8 or Aspect 9, wherein transmitting the indication comprises: broadcasting the indication in system information.

Aspect 11: The method of any of Aspects 8-10, wherein the indication is a first indication, and the method further comprises: transmitting a second indication of a validity duration that is associated with validating differential flight path information.

Aspect 12: The method of any of Aspects 1-11, wherein the flight path information request includes a timestamp that is based at least in part on prior UE flight path information.

Aspect 13: The method of Aspect 12, further comprising: receiving the timestamp from a core network.

Aspect 14: The method of Aspect 12, further comprising: receiving the timestamp from the UE with the prior UE flight path information.

Aspect 15: The method of any of Aspects 1-14, further comprising: receiving, from the UE, a flight path information request response that indicates no change to UE flight path information.

Aspect 16: The method of any of Aspects 1-15, further comprising: receiving, from the UE, a flight path identifier; communicating the flight path identifier to a core network; and receiving, from the core network, UE flight path information that is based at least in part on the flight path identifier.

Aspect 17: The method of any of Aspects 1-16, wherein the flight path information request includes a time stamp associated with prior UE flight path information associated with the UE.

Aspect 18: The method of Aspect 17, wherein the prior UE flight path information is based at least in part on last reported UE flight path information associated with the UE.

Aspect 19: The method of Aspect 18, further comprising: receiving the last reported UE flight path information from a core network.

Aspect 20: The method of Aspect 18, further comprising: receiving the last reported UE flight path information from the UE and prior to transmitting the flight path information request.

Aspect 21: The method of any of Aspects 1-20, further comprising: transmitting differential flight path configuration information.

Aspect 22: The method of Aspect 21, wherein the differential flight path configuration information comprises at least one of: a location change threshold, a time change threshold, a lateral position change threshold, a longitudinal position change threshold, or an altitude change threshold.

Aspect 23: The method of Aspect 21 or Aspect 22, wherein transmitting the differential flight path configuration information comprises: broadcasting the differential flight path configuration information in system information.

Aspect 24: The method of any of Aspects 21-23, wherein transmitting the differential flight path configuration information comprises: transmitting the differential flight path configuration information in a unicast message.

Aspect 25: The method of any of Aspects 1-24, further comprising: communicating the UE flight path information to a core network based at least in part on a next generation application protocol (NGAP) procedure associated with the core network.

Aspect 26: The method of Aspect 25, wherein the NGAP procedure comprises a UE flight path management procedure.

Aspect 27: The method of Aspect 25 or Aspect 26, further comprising: communicating, to the core network, a time stamp associated with generation of the UE flight path information.

Aspect 28: The method of any of Aspects 25-27, wherein the NGAP procedure is based at least in part on an access and mobility management function (AMF) at the core network.

Aspect 29: The method of any of Aspects 25-28, further comprising: receiving, from the core network, a flight plan identifier associated with the UE; and communicating the flight plan identifier to the UE.

Aspect 30: The method of any of Aspects 1-29, further comprising: requesting stored flight path information from an access and mobility management function (AMF) at a core network; and receiving, as a response from the core network, the stored flight path information based at least in part on the AMF at the core network.

Aspect 31: The method of Aspect 30, wherein requesting the stored flight path information comprises: requesting the stored flight path information based at least in part on a setup request procedure and a setup response procedure.

Aspect 32: The method of Aspect 30, wherein requesting the stored flight path information comprises: requesting the stored flight path information based at least in part on a retrieve UE information procedure and a UE information transfer procedure.

Aspect 33: The method of any of Aspects 1-32, further comprising: receiving, from the UE and as the UE flight path information, differential flight path information; and communicating the differential flight path information to a core network.

Aspect 34: The method of any of Aspects 1-33, further comprising: storing the UE flight path information locally.

Aspect 35: A method of wireless communication performed by an apparatus of a user equipment (UE), comprising: receiving an indication that indicates that a network node supports differential flight path information; receiving a flight path information request from the network node; and transmitting a response to the flight path information request that is based at least in part on the network node supporting the differential flight path information.

Aspect 36: The method of Aspect 35, wherein transmitting the response comprises: transmitting UE flight path information based at least in part on receiving the flight path information request, and wherein the method further comprises: updating a last reported flight path buffer based at least in part on the UE flight path information.

Aspect 37: The method of Aspect 36, wherein the UE flight path information comprises full flight path information.

Aspect 38: The method of Aspect 37, further comprising: determining that the differential flight path information is invalid based at least in part on a validity duration; and wherein transmitting the UE flight path information comprises: transmitting the full flight path information based at least in part on determining that the differential flight path information is invalid, wherein transmitting the UE flight path information comprises: transmitting the full flight path information based at least in part on determining that the differential flight path information is invalid.

Aspect 39: The method of Aspect 38, wherein updating the last reported flight path buffer comprises: removing stored flight path information from the last reported flight path buffer.

Aspect 40: The method of Aspect 39, further comprising: storing the full flight path information in the last reported flight path buffer.

Aspect 41: The method of Aspect 36, wherein the UE flight path information comprises the differential flight path information.

Aspect 42: The method of Aspect 41, further comprising: determining that the differential flight path information is valid based at least in part on a validity duration, wherein transmitting the UE flight path information comprises: transmitting, as the UE flight path information, the differential flight path information based at least in part on determining that the differential flight path information is valid, wherein transmitting the UE flight path information comprises: transmitting, as the UE flight path information, the differential flight path information based at least in part on determining that the differential flight path information is valid.

Aspect 43: The method of Aspect 41, wherein the differential flight path information indicates at least one of: an update to a first waypoint included in prior UE flight path information, a removal of a second waypoint from the prior UE flight path information, or an addition of a third waypoint to the prior UE flight path information.

Aspect 44: The method of Aspect 41, further comprising: generating the differential flight path information based at least in part on comparing a current waypoint to a prior waypoint.

Aspect 45: The method of Aspect 44, wherein comparing the current waypoint to the prior waypoint comprises: determining whether a change between the current waypoint and the prior waypoint satisfies a differential threshold.

Aspect 46: The method of Aspect 45, wherein the change comprises at least one of: a location change, or a time difference between the current waypoint and the prior waypoint.

Aspect 47: The method of Aspect 36, wherein updating the last reported flight path buffer comprises: storing a time stamp associated with the UE flight path information in the last reported flight path buffer.

Aspect 48: The method of any of Aspects 35-47, wherein the indication indicates that differential flight path support is enabled.

Aspect 49: The method of Aspect 48, wherein receiving the indication comprises: receiving the indication in system information.

Aspect 50: The method of Aspect 48 or Aspect 49, wherein the indication is a first indication, and the method further comprises: receiving a second indication of a validity duration that is associated with validating the differential flight path information.

Aspect 51: The method of any of Aspects 35-50, wherein the flight path information request includes a timestamp that is based at least in part on prior UE flight path information associated with the UE.

Aspect 52: The method of any of Aspects 35-51, wherein receiving the flight path information request comprises: receiving the flight path information request based at least in part on a unicast message.

Aspect 53: The method of any of Aspects 35-52, further comprising: transmitting a flight path information request response that indicates no change to UE flight path information.

Aspect 54: The method of any of Aspects 35-53, further comprising: transmitting a flight path information request response that includes a flight path identifier.

Aspect 55: The method of Aspect 54, further comprising: receiving, from the network node, the flight path identifier based at least in part on an uncrewed aerial vehicle uncrewed aerial system service supplier authorization and/or authentication (UUAA) procedure.

Aspect 56: The method of any of Aspects 35-55, wherein the flight path information request includes a time stamp associated with prior UE flight path information.

Aspect 57: The method of Aspect 56, wherein the prior UE flight path information is based at least in part on last reported UE flight information associated with the UE.

Aspect 58: The method of any of Aspects 35-57, further comprising: receiving differential flight path configuration information.

Aspect 59: The method of Aspect 58, wherein the differential flight path configuration information comprises at least one of: a location change threshold, a time change threshold, a lateral position change threshold, a longitudinal position change threshold, or an altitude change threshold.

Aspect 60: The method of Aspect 58, wherein receiving the differential flight path configuration information comprises: receiving the differential flight path configuration information in system information.

Aspect 61: The method of Aspect 58, wherein receiving the differential flight path configuration information comprises: receiving the differential flight path configuration information in a unicast message.

Aspect 62: A method of wireless communication performed by an apparatus of a user equipment (UE), comprising: detecting a UE flight path change that satisfies a threshold; and transmitting a flight path change indication to a network node.

Aspect 63: The method of Aspect 62, wherein the UE flight path change is based at least in part on last reported UE flight path information.

Aspect 64: The method of any of Aspects 62-63, wherein transmitting the flight path change indication comprises: transmitting the flight path change indication in a medium access control (MAC) control element (CE).

Aspect 65: The method of any of Aspects 62-64, wherein transmitting the flight path change indication comprises: transmitting the flight path change indication in a UE assistance information message.

Aspect 66: The method of any of Aspects 62-65, further comprising: transmitting current UE flight path information that indicates the UE flight path change.

Aspect 67: The method of Aspect 66, wherein the current UE flight path information comprises: full flight path information; or differential flight path information.

Aspect 68: The method of Aspect 66, further comprising: receiving a flight path information request from the network node, wherein transmitting the current UE flight path information is based at least in part on receiving the flight path information request from the network node.

Aspect 69: The method of Aspect 66, wherein transmitting the current UE flight path information comprises autonomously transmitting the current UE flight path information.

Aspect 70: The method of any of Aspects 62-69, further comprising: receiving an indication that indicates that the network node supports differential flight path information, wherein transmitting the flight path change indication is based at least in part on receiving the indication that the network node supports the differential flight path information.

Aspect 71: A method of wireless communication performed by an apparatus of network node, comprising: receiving, from a user equipment (UE), last reported UE flight path information; and receiving, without transmitting a flight path information request and from the UE, a flight path change indication that is associated with a UE flight path change.

Aspect 72: The method of Aspect 71, wherein the UE flight path change is based at least in part on the last reported UE flight path information.

Aspect 73: The method of any of Aspects 71-72, wherein receiving the flight path change indication comprises: receiving the flight path change indication in a medium access control (MAC) control element (CE).

Aspect 74: The method of any of Aspects 71-73, wherein receiving the flight path change indication comprises: receiving the flight path change indication in a UE assistance information message.

Aspect 75: The method of any of Aspects 71-74 further comprising: receiving current UE flight path information that includes the flight path change indication.

Aspect 76: The method of Aspect 75, wherein the current UE flight path information comprises: full flight path information; or differential flight path information.

Aspect 77: The method of Aspect 75, further comprising: transmitting the flight path information request to the UE based at least in part on receiving the flight path change indication, wherein receiving the current UE flight path information is based at least in part on receiving the flight path information request from the network node.

Aspect 78: The method of Aspect 75, wherein receiving the current UE flight path information comprises autonomously receiving the current UE flight path information without transmitting the flight path information request.

Aspect 79: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 80: An apparatus for wireless communication at a device, the apparatus comprising one or more memories and one or more processors coupled to the one or more memories, the one or more processors configured to cause the device to perform the method of one or more of Aspects 1-34.

Aspect 81: An apparatus for wireless communication, the apparatus comprising at least one means for performing the method of one or more of Aspects 1-34.

Aspect 82: A non-transitory computer-readable medium storing code for wireless communication, the code comprising instructions executable by one or more processors to perform the method of one or more of Aspects 1-34.

Aspect 83: A non-transitory computer-readable medium storing a set of instructions for wireless communication, the set of instructions comprising one or more instructions that, when executed by one or more processors of a device, cause the device to perform the method of one or more of Aspects 1-34.

Aspect 84: A device for wireless communication, the device comprising a processing system that includes one or more processors and one or more memories coupled with the one or more processors, the processing system configured to cause the device to perform the method of one or more of Aspects 1-34.

Aspect 85: An apparatus for wireless communication at a device, the apparatus comprising one or more memories and one or more processors coupled to the one or more memories, the one or more processors individually or collectively configured to cause the device to perform the method of one or more of Aspects 1-34.

Aspect 86: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 35-61.

Aspect 87: An apparatus for wireless communication at a device, the apparatus comprising one or more memories and one or more processors coupled to the one or more memories, the one or more processors configured to cause the device to perform the method of one or more of Aspects 35-61.

Aspect 88: An apparatus for wireless communication, the apparatus comprising at least one means for performing the method of one or more of Aspects 35-61.

Aspect 89: A non-transitory computer-readable medium storing code for wireless communication, the code comprising instructions executable by one or more processors to perform the method of one or more of Aspects 35-61.

Aspect 90: A non-transitory computer-readable medium storing a set of instructions for wireless communication, the set of instructions comprising one or more instructions that, when executed by one or more processors of a device, cause the device to perform the method of one or more of Aspects 35-61.

Aspect 91: A device for wireless communication, the device comprising a processing system that includes one or more processors and one or more memories coupled with the one or more processors, the processing system configured to cause the device to perform the method of one or more of Aspects 35-61.

Aspect 92: An apparatus for wireless communication at a device, the apparatus comprising one or more memories and one or more processors coupled to the one or more memories, the one or more processors individually or collectively configured to cause the device to perform the method of one or more of Aspects 35-61.

Aspect 93: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 62-70.

Aspect 94: An apparatus for wireless communication at a device, the apparatus comprising one or more memories and one or more processors coupled to the one or more memories, the one or more processors configured to cause the device to perform the method of one or more of Aspects 62-70.

Aspect 95: An apparatus for wireless communication, the apparatus comprising at least one means for performing the method of one or more of Aspects 62-70.

Aspect 96: A non-transitory computer-readable medium storing code for wireless communication, the code comprising instructions executable by one or more processors to perform the method of one or more of Aspects 62-70.

Aspect 97: A non-transitory computer-readable medium storing a set of instructions for wireless communication, the set of instructions comprising one or more instructions that, when executed by one or more processors of a device, cause the device to perform the method of one or more of Aspects 62-70.

Aspect 98: A device for wireless communication, the device comprising a processing system that includes one or more processors and one or more memories coupled with the one or more processors, the processing system configured to cause the device to perform the method of one or more of Aspects 62-70.

Aspect 99: An apparatus for wireless communication at a device, the apparatus comprising one or more memories and one or more processors coupled to the one or more memories, the one or more processors individually or collectively configured to cause the device to perform the method of one or more of Aspects 62-70.

Aspect 100: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 71-78.

Aspect 101: An apparatus for wireless communication at a device, the apparatus comprising one or more memories and one or more processors coupled to the one or more memories, the one or more processors configured to cause the device to perform the method of one or more of Aspects 71-78.

Aspect 102: An apparatus for wireless communication, the apparatus comprising at least one means for performing the method of one or more of Aspects 71-78.

Aspect 103: A non-transitory computer-readable medium storing code for wireless communication, the code comprising instructions executable by one or more processors to perform the method of one or more of Aspects 71-78.

Aspect 104: A non-transitory computer-readable medium storing a set of instructions for wireless communication, the set of instructions comprising one or more instructions that, when executed by one or more processors of a device, cause the device to perform the method of one or more of Aspects 71-78.

Aspect 105: A device for wireless communication, the device comprising a processing system that includes one or more processors and one or more memories coupled with the one or more processors, the processing system configured to cause the device to perform the method of one or more of Aspects 71-78.

Aspect 106: An apparatus for wireless communication at a device, the apparatus comprising one or more memories and one or more processors coupled to the one or more memories, the one or more processors individually or collectively configured to cause the device to perform the method of one or more of Aspects 71-78.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network node, comprising:
one or more memories; and
one or more processors, coupled to the one or more memories, configured, individually or collectively, to cause the network node to:
transmit a flight path information request that indicates a differential flight path reporting configuration that is associated with user equipment (UE) flight path information associated with a UE; and
receive the UE flight path information, the UE flight path information being based at least in part on the differential flight path reporting configuration.

2. The apparatus of claim 1, wherein the one or more processors are further configured to cause the network node to:
communicate, to a core network, a flight path query that is associated with the UE; and
receive, from the core network, a response to the flight path query,
wherein the flight path information request is based at least in part on the response from the core network.

3. The apparatus of claim 2, wherein the UE flight path information comprises differential flight path information, and the one or more processors are further configured to cause the network node to:
generate full flight path information based at least in part on the response from the core network and the differential flight path information.

4. The apparatus of claim 1, wherein the one or more processors are further configured to cause the network node to:
transmit an indication that indicates support for differential flight path information.

5. The apparatus of claim 4, wherein the one or more processors are further configured to cause the network node to:
transmit a second indication of a validity duration that is associated with validating differential flight path information.

6. The apparatus of claim 1, wherein the flight path information request includes a timestamp that is based at least in part on prior UE flight path information.

7. The apparatus of claim 1, wherein the one or more processors are further configured to cause the network node to:
receive, from the UE, a flight path information request response that indicates no change to UE flight path information.

8. The apparatus of claim 1, wherein the one or more processors are further configured to cause the network node to:
receive, from the UE, a flight path identifier;
communicate the flight path identifier to a core network; and
receive, from the core network, UE flight path information that is based at least in part on the flight path identifier.

9. The apparatus of claim 1, wherein the one or more processors are further configured to cause the network node to:
transmit differential flight path configuration information.

10. The apparatus of claim 1, wherein the one or more processors are further configured to cause the network node to:
communicate the UE flight path information to a core network based at least in part on a next generation application protocol (NGAP) procedure associated with the core network.

11. The apparatus of claim 1, wherein the one or more processors are further configured to cause the network node to:
request stored flight path information from an access and mobility management function (AMF) at a core network; and
receive, as a response from the core network, the stored flight path information based at least in part on the AMF at the core network.

12. The apparatus of claim 1, wherein the one or more processors are further configured to cause the network node to:
receive, from the UE and as the UE flight path information, differential flight path information; and
communicate the differential flight path information to a core network.

13. The apparatus of claim 1, wherein the one or more processors are further configured to cause the network node to:
store the UE flight path information locally.

14. An apparatus for wireless communication at an UE, comprising:
one or more memories; and
one or more processors, coupled to the one or more memories, configured to cause the UE to:
receive an indication that indicates that a network node supports differential flight path information;
receive a flight path information request from the network node; and
transmit a response to the flight path information request that is based at least in part on the network node supporting the differential flight path information.

15. The apparatus of claim 14, wherein the one or more processors, to cause the UE to transmit the response, are configured to cause the UE to:
transmit UE flight path information based at least in part on receiving the flight path information request, and
wherein the one or more processors are further configured to cause the UE to:
update a last reported flight path buffer based at least in part on the UE flight path information.

16. The apparatus of claim 15, wherein the UE flight path information comprises full flight path information.

17. The apparatus of claim 16, wherein the one or more processors are further configured to cause the UE to:
determine that the differential flight path information is invalid based at least in part on a validity duration; and
wherein the one or more processors, to cause the UE to transmit the UE flight path information, are configured to cause the UE to:
transmit the full flight path information based at least in part on determining that the differential flight path information is invalid.

18. The apparatus of claim 15, wherein the UE flight path information comprises the differential flight path information.

19. The apparatus of claim 15, wherein the flight path information request includes a timestamp that is based at least in part on prior UE flight path information associated with the UE.

20. The apparatus of claim 14, wherein the one or more processors are further configured to cause the UE to:
transmit a flight path information request response that indicates no change to UE flight path information.

21. The apparatus of claim 14, wherein the one or more processors are further configured to cause the UE to:
transmit a flight path information request response that includes a flight path identifier.

22. The apparatus of claim 14, wherein the one or more processors are further configured to cause the UE to:
receive differential flight path configuration information.

23. An apparatus for wireless communication at an UE, comprising:
one or more memories; and
one or more processors, coupled to the one or more memories, configured to cause the UE to:
detect a UE flight path change that satisfies a threshold; and
transmit a flight path change indication to a network node.

24. The apparatus of claim 23, wherein the UE flight path change is based at least in part on last reported UE flight path information.

25. The apparatus of claim 23, wherein the one or more processors are further configured to cause the UE to:
transmit current UE flight path information that indicates the UE flight path change.

26. The apparatus of claim 25, wherein the one or more processors are further configured to cause the UE to:
receive a flight path information request from the network node, wherein transmitting the current UE flight path information is based at least in part on receiving the flight path information request from the network node.

27. An apparatus for wireless communication at a network node, comprising:
one or more memories; and
one or more processors, coupled to the one or more memories, configured to cause the network node to:
receive, from a user equipment (UE), last reported UE flight path information; and
receive, without transmitting a flight path information request and from the UE, a flight path change indication that is associated with a UE flight path change.

28. The apparatus of claim 27, wherein the one or more processors, to cause the network node to receive the flight path change indication, are configured to cause the network node to:
receive the flight path change indication in at least one of:
a medium access control (MAC) control element (CE), or UE assistance information message.

29. The apparatus of claim 27, wherein the one or more processors are further configured to cause the network node to:
receive current UE flight path information that includes the flight path change indication.

30. The apparatus of claim 29, wherein the one or more processors, to cause the network node to receive the current UE flight path information, are configured to cause the network node to autonomously receive the current UE flight path information without transmitting the flight path information request.
